(19) United States
(12) Patent Application Publication
(10) Pub. No.: US 2022/0291361 A1
(43) Pub. Date: Sep. 15, 2022

(54) USE OF CIRCULATOR IN LIDAR SYSTEM

(71) Applicant: SiLC Technologies, Inc., Monrovia, CA (US)

(72) Inventors: Mehdi Asghari, La Canada Flintridge, CA (US); Prakash Koonath, La Crescenta, CA (US); Vala Fathipour, Pasadena, CA (US); Bradley Jonathan Luff, La Canada Flintridge, CA (US)

(21) Appl. No.: 17/221,770

(22) Filed: Apr. 2, 2021

Related U.S. Application Data
(60) Provisional application No. 63/160,796, filed on Mar. 13, 2021.

(51) Int. Cl. G01S 7/499; G01S 17/08; G01S 17/58

(52) U.S. Cl. CPC G01S 7/499; G01S 17/08; G01S 17/58

(57) ABSTRACT

A LIDAR system has a circulator outputs multiple different outgoing circulator signals. The circulator receives multiple different circulator return signals. Each of the circulator return signals includes light that was included in one of the outgoing circulator signals and was reflected by one or more objects located outside of the LIDAR system. The circulator is configured to output multiple circulator output signals that each includes light from one of the circulator return signals. The LIDAR system also includes electronics that use the circulator output signals to generate one or more LIDAR data results. The LIDAR data results are selected from a group consisting of a distance and a radial velocity between the LIDAR system and the one or more objects.

### RELATED APPLICATIONS

This application claims the benefit of U.S. Provisional Patent Application serial number 63/160,796, filed in Mar. 13, 2021, entitled “LIDAR System Processing Multiple Channels in a Common Circulator,” and incorporated herein in its entirety.

### FIELD

The invention relates to optical devices. In particular, the invention relates to LIDAR systems.

### BACKGROUND

The demands on the performance of LIDAR systems are increasing. In particular, many LIDAR system applications require increases in the resolution of the LIDAR system and/or increases in the field of view of the LIDAR system. One method of meeting these demands is to increase the number of LIDAR signals that are output by the LIDAR system. However, current LIDAR systems make use of an optical circulator to separate incoming light signals from outgoing light signals. Increasing the number of LIDAR signals output from the LIDAR system generally requires as increase in the number of circulators and/or in the number of components associated with the circulator. This increase in the number of circulators and associated components can undesirably increase the complexity and/or cost of the LIDAR system. As a result, there is a need for a LIDAR system that can meet the increasing performance demands.

### SUMMARY

A LIDAR system has a circulator that outputs multiple different outgoing circulator signals. The circulator receives multiple different circulator return signals. Each of the circulator return signals includes light that was included in one of the outgoing circulator signals and was reflected by one or more objects located outside of the LIDAR system. The circulator is configured to output multiple circulator output signals that each includes light from one of the circulator return signals. The LIDAR system also includes electronics that use the circulator output signals to generate one or more LIDAR data results. The LIDAR data results are selected from a group consisting of a distance and a radial velocity between the LIDAR system and the one or more objects.

In some instances, a portion of the circulator output signals are first circulator output signals and a portion of the circulator output signals are second circulator output signals. The first circulator output signals include primarily light that was reflected by the one or more objects in a first polarization state. The second circulator output signals include primarily light that was reflected by the one or more objects in a second polarization state. Additionally, the circulator output signals include multiple pairs. Each pair of circulator output signals includes one of the first circulator output signals and one of the second circulator output signals. The first circulator output signal and the second circulator output signal included in each pair both include primarily light from the same circulator return signal.

Another embodiment of a LIDAR system is configured to direct a system output signal multiple different sample regions in a field of view. The LIDAR system is configured to generate LIDAR data for each sample region. The LIDAR data for each sample region indicates the distance and/or radial velocity between the LIDAR system and an object in the sample region. The LIDAR system includes multiple waveguides that are each configured to receive a light signal that includes light from the system output signal. The waveguide that receives the light signal is a function of the distance between the LIDAR system and the object.

### BRIEF DESCRIPTION OF THE FIGURES

FIG. 1 is a top view of a LIDAR chip that is suitable for use with a LIDAR adapter.

FIG. 2 is a top view of a LIDAR chip that is suitable for use with a LIDAR adapter.

FIG. 3A is a top view of a portion of a LIDAR system having a LIDAR adapter in optical communication with a LIDAR chip. A pathway that light signals carrying channel C₂ travel from the LIDAR chip, through the LIDAR adapter, and then out of the LIDAR system is illustrated.

FIG. 3B is the LIDAR system of FIG. 3A. A pathway that light signals carrying channel C₂ travel from outside of the LIDAR system, through the LIDAR adapter, and into the LIDAR chip is illustrated.

FIG. 3C is the LIDAR system of FIG. 3A. A pathway that light signals carrying channel C₃ travel travels through the LIDAR system is illustrated.

FIG. 4 is a topview of a LIDAR system that includes the LIDAR chip and electronics of FIG. 2 and the LIDAR adapter of FIG. 3 on a common support.

FIG. 5A illustrates an example of a processing component suitable for use with the LIDAR chip of FIG. 1.

FIG. 5B provides a schematic of electronics that are suitable for use with a processing component constructed according to FIG. 5A.

FIG. 5C is a graph of frequency versus time for a LIDAR output signal.

FIG. 6A is a topview of a LIDAR chip.

FIG. 6B is a topview of a LIDAR system that includes the LIDAR chip of FIG. 6A. The LIDAR system includes multiple waveguides that are each configured to receive a light signal and the waveguide that receives the light signal changes in response to changes in the distance between the LIDAR system and an object located outside of the LIDAR system.

FIG. 6C is a topview of a LIDAR system that includes multiple waveguides that are each configured to receive a light signal and the waveguide that receives the light signal changes in response to changes in the distance between the LIDAR system and an object located outside of the LIDAR system.

FIG. 7 is a cross-section of portion of a chip constructed from a silicon-on-insulator wafer.

### DESCRIPTION

A LIDAR system can be configured to concurrently output multiple different system output signals that each carries a different channel. The light from the system output signals can be reflected by an object located outside of the system and can return to the LIDAR system in system return signals. The LIDAR system includes a circulator. The light in the system output signals passed through the circulator before the system output signals exited from the LIDAR system. Additionally, the light from the system return signals passes through the circulator after the system return signals return to the LIDAR system. Since the light for multiple system output signals and the light from multiple system return signals is processed by the same circulator, increasing the number of system output signals that are transmitted from the LIDAR system does not require additional circulators.

Further, the circulator can account for changes in the polarization state of the light that is reflected by objects located outside of the LIDAR system. For instance, signals that carry light reflected in a first polarization state can exit from the circulator at one port and signals that carry light reflected in a second polarization can exit from the circulator at a second port. As a result, the LIDAR system can account for light signals in different polarization states. The ability of a single circulator to output an increased number of system output signals while also accounting for different polarization states, allows the performance of the LIDAR system to be increased without substantial increases in costs or complexity.

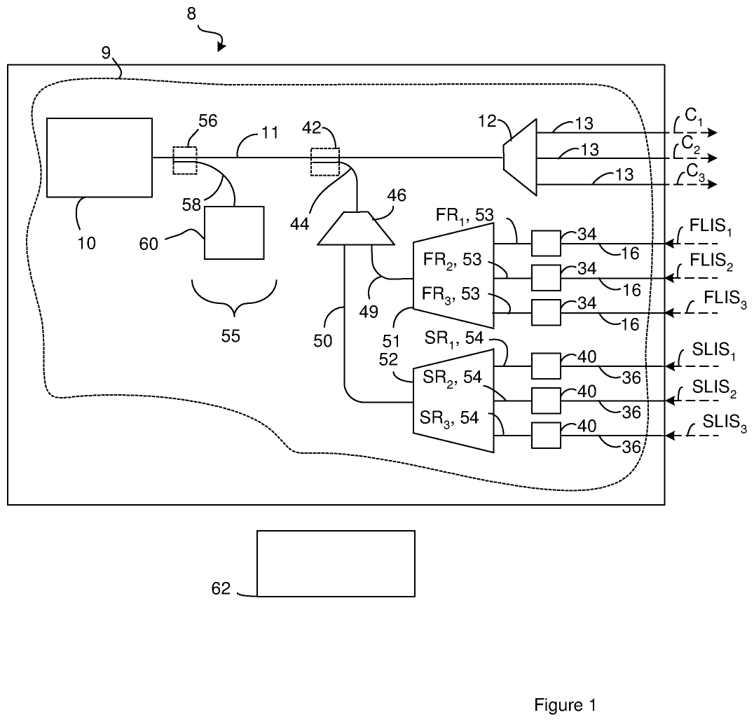

FIG. 1 is a topview of a LIDAR chip 8 that includes chip components 9. The LIDAR chip can include a Photonic Integrated Circuit (PIC) and can be a Photonic Integrated Circuit (PIC) chip. The chip components 9 include a light source 10 that outputs a light source output signal. The light source output signal can one or more preliminary channels that can each be represented by PCⱼ where j is a preliminary channel index with an integer value from 1 to N. Each of the preliminary channels (PCⱼ) is associated with a different wavelength.

When the light source output signal is to carry a single preliminary channel, suitable light sources 10 include but are not limited to, single channel lasers such as single channel semiconductor lasers. When the light source output signal is to carry multiple preliminary channels (PCⱼ), suitable light sources 10 include but are not limited to, multi-channel lasers such as a semiconductor laser that produces a wavelength comb. Alternately, when the light source output signal is to carry multiple preliminary channels, the light source 10 can include multiple different lasers and the outputs of the lasers can be combined so as to form the light source output signal.

The chip components 9 include a source waveguide 11 that receives the light source output signal from the light source 10. The source waveguide 11 carries the light source output signal to a splitter 12. The splitter 12 is configured to divide the light source output signal into multiple different outgoing LIDAR signals that are each received on a different utility waveguide 13. Each of the utility waveguides 13 carries one of the outgoing LIDAR signals to an exit port through which the outgoing LIDAR signal can exit from the LIDAR chip and serve as a LIDAR output signal. Examples of suitable exit ports include, but are not limited to, waveguide facets such as the facets of the utility waveguides 13.

The splitter 12 can be a wavelength dependent splitter. For instance, the splitter 12 can be configured such that each of the LIDAR output signal carries a different selection of wavelengths. For instance, examples of suitable wavelength dependent splitter splitters 12 include, but are not limited to, demultiplexers such as arrayed waveguide gratings, echelle gratings, and ring resonator based devices. Accordingly, when the light source output signal carries multiple preliminary channels (PCⱼ with N=>2), each of the LIDAR output signals can carry a different channel represented by Cᵢ where i is a channel index with an integer value from 1 to M. When the splitter 12 is a wavelength dependent splitter, the splitter 12 can be configured such that the channel indices in the channel representation Cᵢ correspond to the preliminary channel indices in the preliminary channel representation PCⱼ. For instance, the splitter 12 can be configured such that channel index i=channel index j. As a result, each of the preliminary channels (PCⱼ) serves as a channel (Cᵢ) carried by a different one of the LIDAR output signals.

FIG. 1 has multiple arrows that each represents a LIDAR output signal traveling away from a utility waveguide 13. For the purposes of illustration, the LIDAR system is shown as generating three LIDAR output signals (N=3) labeled C₁ through C₃.

Light from each of the LIDAR output signals can be included in a system output signal that is output from the LIDAR system. The system output signals travel away from the LIDAR system and can each be reflected by an object(s) in the path of the system output signal. Light from a reflected system output signal can return to the LIDAR system as a system return signal.

The LIDAR chip includes multiple first input waveguides 16. Each of the first input waveguides 16 can receive a first LIDAR input signal that includes or consists of light from one of the system return signals. The first LIDAR input signals each carries one of the channels (CO and can be represented by FLISᵢ where i is the channel index. The first LIDAR input signal that carries the channel C₁ is labeled FLIS_{C1} and is received at one of the first input waveguides 16. The first LIDAR input signal that carries the channel C₃ is labeled FLIS_{C3} and is received at one of the first input waveguides 16.

Each of the first LIDAR input signals enters one of the first input waveguides 16 and serves as a first comparative signal. Each of the first input waveguides 16 carries one of the first comparative signals to a first processing component 34.

The LIDAR chip includes one or more second input waveguides 36. Each of the second input waveguides 36 can receive a second LIDAR input signal that includes or consists of light from one of the system return signals. Each of the second LIDAR input signals carries one of the channels (Cᵢ) and can be represented by SLISᵢ where i is the channel index. The second LIDAR input signal that carries the channel C₁ is labeled SLIS_{C1} and is received at one of the second input waveguides 36. The second LIDAR input signal that carries the channel C₃ is labeled SLIS_{C3} and is received at one of the second input waveguides 36.

The second LIDAR input signals each enters one of the second input waveguides 36 and serves as a second comparative signal. Each of the second input waveguides 36 carries one of the second comparative signals to a second processing component 40.

The chip components 9 include a splitter 42 configured to move a portion of the light source output signal from the source waveguide 11 onto an intermediate waveguide 44 as an intermediate signal. The splitter 42 can be a wavelength independent splitter. As a result, the intermediate signal can have the same or substantially the same wavelength distribution. Suitable splitters 42 include, but are not limited to, evanescent optical couplers, y-junctions, and MMIs.

The LIDAR chip also includes an intermediate splitter 46 configured to receive the intermediate signal and divide the intermediate signal into a first intermediate signal received on a first intermediate waveguide 49 and a second intermediate signal received on a second intermediate waveguide 50. The intermediate splitter 46 can be a wavelength independent splitter. As a result, the first intermediate signal and the second intermediate signal can have the same or substantially the same wavelength distribution. Suitable intermediate splitters 46 include, but are not limited to, evanescent optical couplers, y-junctions, and MMIs.

The first intermediate waveguide 49 carries the first intermediate signal to a first channel splitter 51. The first channel splitter 51 is configured to divide the first intermediate signal into first reference signals that are each received at a different first reference waveguide 53.

The first channel splitter 51 can be a wavelength dependent splitter. For instance, the first channel splitter 51can be configured such that each of the first reference signals carries a different selection of wavelengths. Suitable first channel splitters 51 include, but are not limited to, demultiplexers such as arrayed waveguide gratings, echelle gratings, and ring resonator based devices. As a result, each of the first reference signals can carry a different one of the preliminary channels (PCⱼ) and accordingly, a different one of the channels (CO. For instance, the first reference signals can be represented by FRᵢ where i represents the channel index from the channel representation channel Cᵢ. Accordingly, the first reference signal represented by FRᵢ and the channel (Cᵢ) with the same channel index carry the same channel. As an example, the first reference waveguide 53 labeled FR₁ guides the first reference signal that carries the preliminary channel PC₁ that serves as channel C₁. As another example, the first reference waveguide 53 labeled FR₃ guides the first reference signal that carries the preliminary channel PC₃ that serves as channel C₃.

Each of the first reference waveguides 53 guides one of the first reference signals to one of the processing components 34. The first reference waveguide 53 and the first input waveguides 16 are arranged such that each processing component 34 receives a first reference signal and a first LIDAR input signal carrying the same channel. The LIDAR system is configured to use the first reference signal and the first LIDAR input signal received at a processing component 34 to generate LIDAR data.

The second intermediate waveguide 50 carries the second intermediate signal to a second channel splitter 52. The second channel splitter 52 is configured to divide the second intermediate signals into second reference signals that are each received at a different second reference waveguide 54. The second channel splitter 52 can be a wavelength dependent splitter. For instance, the second channel splitter 52 can be configured such that each of the second reference signals carries a different selection of wavelengths. Suitable second channel splitters 52 include, but are not limited to, demultiplexers such as arrayed waveguide gratings, echelle gratings, and ring resonator based devices. Accordingly, each of the second reference signals can carry a different one of the preliminary channels (PCⱼ) and accordingly, a different one of the channels (Cᵢ). For instance, the second reference signals can be represented by SRᵢ where i represents the channel index from the channel representation channel Cᵢ. Accordingly, the second reference signal represented by SRᵢ and the channel (Cᵢ) with the same channel index carry the same channel. As an example, the second reference waveguide 54 labeled SR₁ guides the second reference signal carrying the preliminary channel PCᵢ that serves as channel C₁. As another example, the second reference waveguide 54 labeled SR₃ guides the second reference signal carrying the preliminary channel PC₃ that serves as channel C₃.

Each of the second reference waveguides 54 guides one of the second reference signals to one of the second processing components 40. The second reference waveguide 54 and the second input waveguides 36 are arranged such that each second processing component 40 receives a second reference signal and a second LIDAR input signal carrying the preliminary channel and accordingly the same channel. The LIDAR system is configured to use the second reference signal and the second LIDAR input signal received at a second processing component 40 to generate LIDAR data.

The LIDAR chip can include a control branch 55 for controlling operation of the light source 10. The control branch 55 includes a directional coupler 56 that moves a portion of the source output signal from the source waveguide 11 onto a control waveguide 58. The coupled portion of the source output signal serves as a tapped signal. Although FIG. 1 illustrates a directional coupler 56 moving portion of the source output signal onto the control waveguide 58, other signal-tapping components can be used to move a portion of the source output signal from the utility waveguide 12 onto the control waveguide 58. Examples of suitable signal tapping components include, but are not limited to, y-junctions, and MMIs.

The control waveguide 58 carries the tapped signal to control components 60. The control components 60 can be in electrical communication with electronics 62. During operation, the electronics 62 can adjust the frequency of the source output signal in response to output from the control components. An example of a suitable construction of control components is provided in U.S. patent application Ser. No. 15/977,957, filed on 11 May 2018, entitled “Optical Sensor Chip,” and incorporated herein in its entirety.

Suitable electronics 62 can include, but are not limited to, a controller that includes or consists of analog electrical circuits, digital electrical circuits, processors, microprocessors, digital signal processors (DSPs), computers, microcomputers, or combinations suitable for performing the operation, monitoring and control functions described above. In some instances, the controller has access to a memory that includes instructions to be executed by the controller during performance of the operation, control and monitoring functions. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

Although the light source 10 is shown as being positioned on the LIDAR chip, all or a portion of the light source 10 can be located off the LIDAR chip.

FIG. 1 is disclosed in the context of a LIDAR system where the light source output signal carries multiple different preliminary channels (PCⱼ). However, the LIDAR system of FIG. 1 can be configured to operate with a light source output signal that carries a single preliminary channel that can be represented by PC₁. For instance, the LIDAR chip of FIG. 1 can be configured such that the splitter 12, the first channel splitter 51, and the second channel splitter 52 are each a wavelength independent splitter such as an optical coupler, y-junction, MMI, cascaded evanescent optical couplers, or cascaded y-junctions. As a result, the LIDAR output signals can each have the same, or about the same, distribution of wavelengths; the first LIDAR input signals each have the same, or about the same, distribution of wavelengths; and the second LIDAR input signals each have the same, or about the same, distribution of wavelengths. As a result, the preliminary channel PC₁ serves as each of the different channels Cᵢ. Accordingly, each of the channels Cᵢ is associated with the same wavelength.

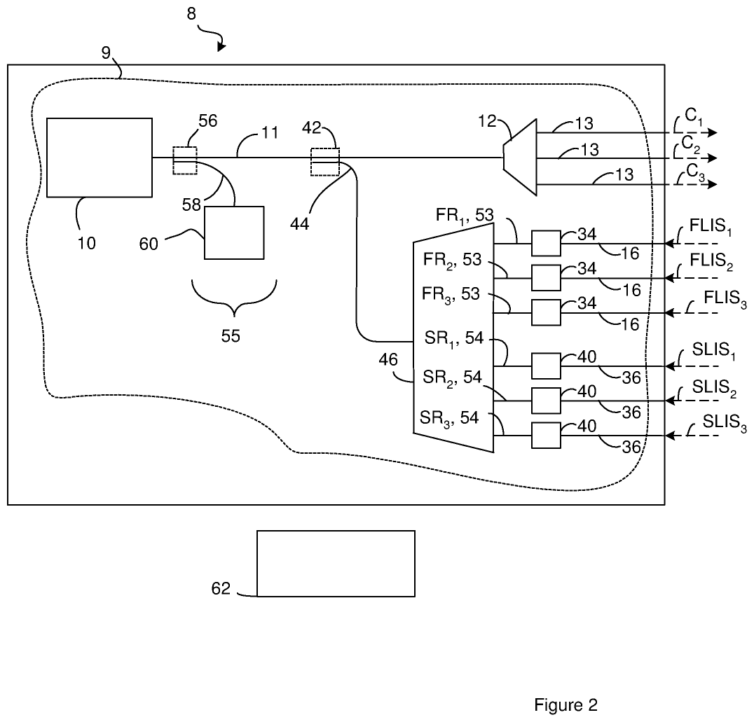

FIG. 2 illustrates an example of LIDAR chip configured to operate with a light source output signal that carries a single preliminary channel that can be represented by PC₁. The splitter 12 is a wavelength independent splitter such as an evanescent optical coupler, y-junction, MMI, cascaded evanescent optical couplers, or cascaded y-junctions . A wavelength independent splitter can provide the LIDAR output signals (labeled Cᵢ) with the same, or about the same, distribution of wavelengths as each other and also the same, or about the same, distribution of wavelengths as the preliminary channel that can be represented by PC₁. As a result, the preliminary channel PCᵢ can serve as each of the different channels Cᵢ with the LIDAR output signals (labeled Cᵢ). Accordingly, each of the channels Cᵢ can be associated with the same wavelength.

In FIG. 2, the intermediate splitter 46 replaces the intermediate splitter 46, the first channel splitter 51, and the second channel splitter 52 of FIG. 1. In this instance, the intermediate splitter 46 is configured to receive the intermediate signal from the intermediate waveguide 44 and divide the intermediate signal into the first reference signals represented by FRᵢ, and the second reference signals represented by SRᵢ. The intermediate splitter 46 is a wavelength independent splitter such as an optical coupler, y-junction, MMI, cascaded evanescent optical couplers, or cascaded y-junctions. A wavelength independent splitter can provide the first reference signals (FRᵢ) and the second reference signals (SRᵢ) with the same, or about the same, distribution of wavelengths as each other and also the same, or about the same, distribution of wavelengths as the intermediate signal. Since the intermediate signal is a sample of a light source output signal carrying the preliminary channel represented by PC₁, the preliminary channel PC₁ can serve as the channel carried by the first reference signals (FRᵢ) and the second reference signals (SRᵢ). Accordingly, each of the channels carried by the first reference signals (FRᵢ) and the second reference signals (SRᵢ) can be associated with the same wavelength.

The LIDAR chips can be used in conjunction with a LIDAR adapter. In some instances, the LIDAR adapter can be optically positioned between the LIDAR chip and the one or more reflecting objects and/or the field of view in that an optical path that the LIDAR output signals travel from the LIDAR chip to the field of view passes through the LIDAR adapter. Additionally, the LIDAR adapter can be configured such that the LIDAR output signals, the first LIDAR input signals and the second LIDAR input signals travel on different optical pathways between the LIDAR adapter and the reflecting object(s).

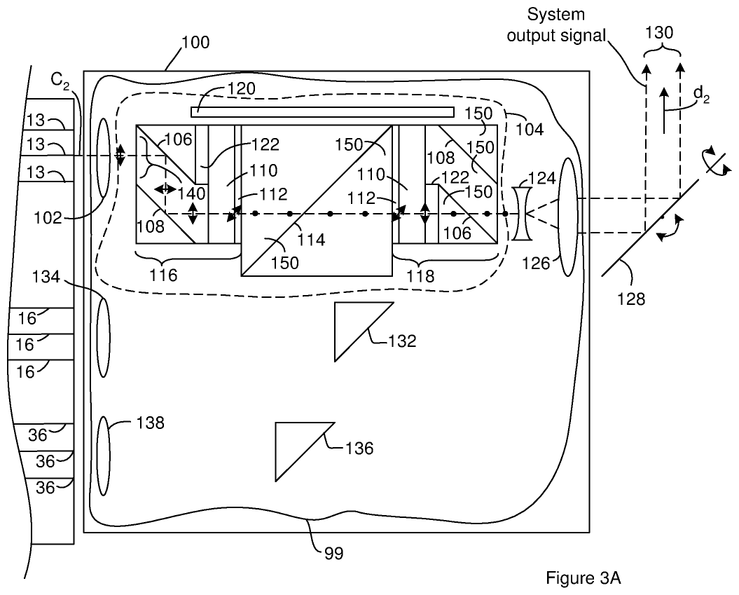

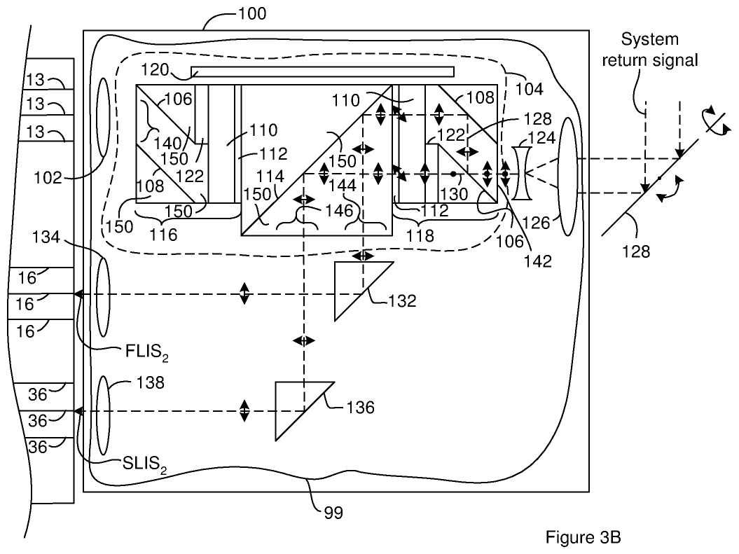

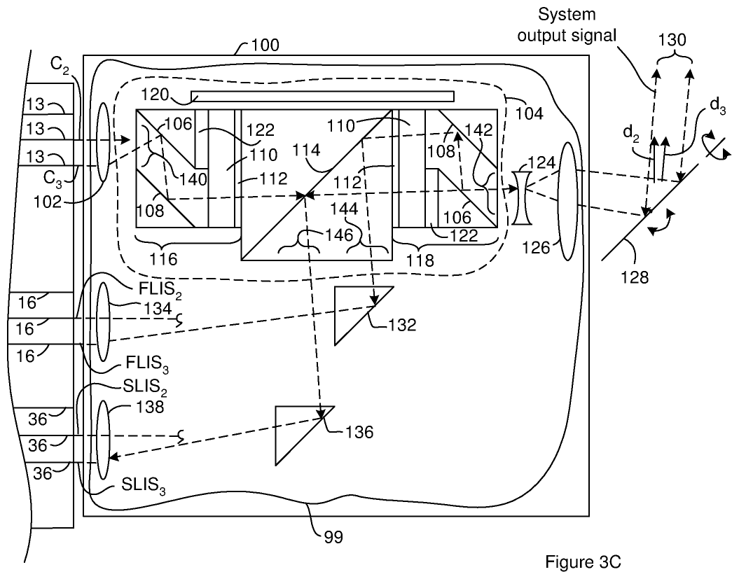

An example of a LIDAR adapter that is suitable for use with the LIDAR chip of FIG. 1 and FIG. 2 is illustrated in FIG. 3A and FIG. 3B. A path of the light signals that carry the channel C₂ is shown in FIG. 3A and FIG. 3B. The path shown in FIG. 3A follows light from the LIDAR output signal carrying channel C₂ traveling from the LIDAR chip through the adapter until it exits the LIDAR system as a system output signal. In contrast, FIG. 3B follows light from the system return signals carrying channel C₂ traveling through the adapter until it enters the LIDAR chip in a first LIDAR input signal and a second LIDAR input signal.

The LIDAR adapter 98 includes multiple adapter components 99 positioned on a base 100. The adapter components 99 include a pre-circulator component 102 positioned to receive the LIDAR output signal carrying channel C₂ from the LIDAR chip and to output a circulator input signal. As will be described in more detail below, the adapter components 99 can include a circulator 104 and the pre-circulator component 102 can be configured to output multiple circulator input signals that enter the circulator traveling in different non-parallel directions. Additionally or alternately, the pre-circulator component 102 can be configured such that the circulator input signals are focused or collimated at a desired location. For instance, the pre-circulator component 102 can be configured to focus or collimate the circulator input signal at a desired location on the circulator 104. The illustrated pre-circulator component 102 is a lens.

The circulator 104 can include a first polarization beam splitter 106 that receives the circulator input signal. The first polarization beam splitter 106 is configured to split the circulator input signal into a light signal in a first polarization state and a light signal in a second polarization state signal. The first polarization state and the second polarization state can be linear polarization states and the second polarization state is different from the first polarization state. For instance, the first polarization state can be TE and the second polarization state can be TM or the first polarization state can be TM and the second polarization state can be TE.

Because the light source 10 often includes one or more lasers as the source of the light source output signal, the light source output signal can be linearly polarized. Since the light source output signal is the source of the circulator input signals, the circulator input signals received by the first polarization beam splitter 106 can also be linearly polarized. In FIG. 3A and FIG. 3B, light signals with the first polarization state are labeled with vertical bi-directional arrows and light signals with the polarization state are labeled filled circles. For the purposes of the following discussion, the circulator input signals are assumed to be in the first polarization state, however, the circulator input signals in the second polarization state are also possible. Since the circulator input signals are assumed to be in the first polarization state, the circulator input signals are labeled with vertical arrows.

Since the circulator input signals are assumed to be in the first polarization state, the first polarization beam splitter 106 is shown outputting a first polarization state signal in the first polarization state. However, the first polarization beam splitter 106 is not shown outputting a light signal in the second polarization state due to a lack of a substantial amount of the second polarization state in the circulator input signals.

The circulator 104 can include a second polarization beam splitter 108 that receives the first polarization state signal. The second polarization beam splitter 108 splits the first polarization state signal into a first polarization signal and a second polarization signal where the first polarization signal has a first polarization state but does not have, or does not substantially have, a second polarization state and the second polarization signal has the second polarization state but does not have, or does not substantially have, the first polarization state. Since the first polarization state signal received by the second polarization beam splitter 108 has the first polarization state but does not have, or does not substantially have, the second polarization state; the second polarization beam splitter 108 outputs the first polarization signal but does not substantially output the second polarization signal. The first polarization beam splitter 106 and the second polarization beam splitter 108 can have the combined effect of filtering one of the polarization states from the circulator input signals.

The circulator 104 can include a non-reciprocal polarization rotator 110 that receive the first polarization signal and outputs a first rotated signal. In some instances, the non-reciprocal polarization rotator 110 is configured to rotate the polarization state of the first polarization signal by n*90°+45° where n is 0 or an even integer. As a result, the polarization state of the first rotated signal is rotated by 45° from the polarization state of the first polarization signal. Suitable non-reciprocal polarization rotators 110 include, but are not limited to, non-reciprocal polarization rotators such as Faraday rotators.

The circulator 104 can include a 45° polarization rotator 112 that receives the first rotated signal and outputs a second rotated signal. In some instances, the 45° polarization rotator 112 is configured to rotate the polarization state of the first rotated signal by m*90°+45° where m is 0 or an even integer. As a result, the polarization state of the second rotated signal is rotated by 45° from the polarization state of the first rotated signal. The combined effect of the polarization state rotations provided by the non-reciprocal polarization rotator 110 and the 45° polarization rotator 112 is that the polarization state of the second rotated signal is rotated by 90° relative to the polarization state of the first polarization signal. Accordingly, in the illustrated example, the second rotated signal has the second polarization state. Suitable 45° polarization rotators 112 include, but are not limited to, reciprocal polarization rotators such as half wave plates.

The circulator 104 can include a third polarization beam splitter 114 that receives the second rotated signal from the 45° polarization rotator 112. The third polarization beam splitter 114 is configured to split the second rotated signal into a light signal in the first polarization state and a light signal in the second polarization state signal. Since the second rotated signal is in the second polarization state, the third polarization beam splitter 108 outputs the second rotated signal but does not substantially output a signal in the first polarization state.

As is evident from FIG. 3A, the first polarization beam splitter 106, the second polarization beam splitter 108, the non-reciprocal polarization rotator 110, and the 45° polarization rotator 112 can be included in a component assembly 116. The component assembly 116 can be constructed as a monolithic block in that the components of the component assembly 116 can be bonded together in a block. In some instances, the component assembly 116 has the geometry of a cube, cuboid, square cuboid, or rectangular cuboid.

The circulator 104 can include a second component assembly 118. In some instances, the second component assembly 118 has the same construction as the component assembly 116. As a result, the component assembly 116 can also serve as the second component assembly 118. The second component assembly 118 can receive the second rotated signal from the third polarization beam splitter 108. In particular, the 45° polarization rotator 112 in the second component assembly 118 can receive the second rotated signal from the third polarization beam splitter 108 and output a third rotated signal. In some instances, the 45° polarization rotator 112 is configured to rotate the polarization state of the second rotated signal by m*90°+45° where m is 0 or an even integer. As a result, the polarization state of the third rotated signal is rotated by 45° from the polarization state of the second rotated signal. Suitable 45° polarization rotators 112 include, but are not limited to, reciprocal polarization rotators such as half wave plates.

The second component assembly 118 can include a non-reciprocal polarization rotator 110 that receive the third rotated signal and outputs a fourth rotated signal. In some instances, the non-reciprocal polarization rotator 110 is configured to rotate the polarization state of the third polarization signal by n*90°+45° where n is 0 or an even integer. As a result, the polarization state of the fourth rotated signal is rotated by 45° from the polarization state of the third polarization signal. Suitable non-reciprocal polarization rotators 110 include, but are not limited to, non-reciprocal polarization rotators such as Faraday rotators.

The combined effect of the polarization state rotations provided by the non-reciprocal polarization rotator 110 and the 45° polarization rotator 112 in the second component assembly 118 is that the polarization state of the fourth rotated signal is rotated by 90° relative to the polarization state of the second polarization signal. Accordingly, in the illustrated example, the fourth rotated signal has the first polarization state.

When the non-reciprocal polarization rotator 110 in the first component assembly 116 and the non-reciprocal polarization rotator 110 in the first component assembly 118 are each a Faraday rotator, the adapter components 99 can include a magnet 120 positioned to provide the magnetic field that provides the Faraday rotators with the desired functionality.

The second component assembly 118 can include a 90° polarization rotator 122 that receives the fourth rotated signal and outputs a fifth rotated signal. In some instances, the 90° polarization rotator 122 is configured to rotate the polarization state of the first rotated signal by n*90°+90° where n is 0 or an even integer. As a result, the polarization state of the fifth rotated signal is rotated by 90° from the polarization state of the fourth rotated signal. The combined effect of the polarization state rotations provided by the non-reciprocal polarization rotator 110, the 45° polarization rotator 112, and the 90° polarization rotator 122 is that the polarization state of the fifth rotated signal is rotated by 0° relative to the polarization state of the second rotated signal. Accordingly, in the illustrated example, the fifth rotated signal has the second polarization state. Suitable 90° polarization rotators 122 include, but are not limited to, reciprocal polarization rotators such as half wave plates.

In instances where the second component assembly 118 has the same construction as the component assembly 116, the 90° polarization rotator 122 may also be present in the component assembly 116.

The first polarization beam splitter 106 in the component assembly 116 receives the fifth rotated signal. The first polarization beam splitter 106 is configured to split the received light signal into a light signal with the first polarization state and a light signal with the second polarization state. Because the fifth rotated signal is in the second polarization state and does not have a component, or does not have a substantial component, in the first polarization state, the first polarization beam splitter 106 outputs an outgoing circulator signal having the second polarization state. As illustrated in FIG. 3A, the outgoing circulator signal exits from the circulator.

The adapter components 99 include a beam shaper 124 positioned to receive the outgoing circulator signal. In some instances, the beam shaper 124 is configured to expand the width of the outgoing circulator signal. Suitable beam shapers 124 include, but are not limited to, concave lenses, convex lenses, plano concave lenses, and plano convex lenses.

The adapter components 99 include a collimator 126 that receives the shaped outgoing circulator signal and to output a collimated outgoing circulator signal. Suitable collimators 126 include, but are not limited to, convex lenses and GRIN lenses.

The LIDAR systems of FIG. 3A can optionally include one or more beam steering components 128 that receive the collimated outgoing circulator signal from the collimator 126 and that output the system output signal carrying the channel C₂. The direction that the system output signal carrying channel C₂ travels away from the LIDAR system is labeled d₂ in FIG. 3A. The electronics can operate the one or more beam steering components 128 so as to steer the system output signal to different sample regions 129. The sample regions can extend away from the LIDAR system to a maximum distance for which the LIDAR system is configured to provide reliable LIDAR data. The sample regions can be stitched together to define the field of view. For instance, the field of view of for the LIDAR system includes or consists of the space occupied by the combination of the sample regions.

Suitable beam steering components 128 include, but are not limited to, movable mirrors, MEMS mirrors, optical phased arrays (OPAs), optical gratings, and actuated optical gratings.

FIG. 3B shows the path that light from the system return signals carrying channel C₂ travels through the adapter of FIG. 3A until it enters the LIDAR chip in a first LIDAR input signal and a second LIDAR input signal.

The system return signal is received by the one or more beam steering components 128. The one or more beam steering components 128 output a steered return signal directed to the beam shaper 124. In instances where the beam shaper 124 is configured to expand the width of the outgoing circulator signal, the beam shaper 124 contracts the width of the steered return signal.

The beam shaper 124 outputs a circulator return signal that is received by the oscillator. In particular, the circulator return signal is received by the first polarization beam splitter 106 in the second component assembly 118. As noted above, a possible result of using one or more lasers is the light source 10 is that the system output signals are linearly polarized. For instance, the light carried by the system output signal is all of, or is substantially all of, the first polarization state or the second polarization state. Reflection of the system output signal by an object may change the polarization state of all or a portion of the light in the system output signal. Accordingly, the system return signal can include light of different linear polarization states. For instance, the system return signal can have a first contribution from light in the first polarization state and a second contribution from light in the second polarization state. The first polarization beam splitter 106 can be configured to separate the first contribution and the second contribution. For instance, the first polarization beam splitter 106 can be configured to output a first separated signal 128 that carries light in the first polarization state and a second separated signal 130 that carries light in the second polarization state.

The second polarization beam splitter 108 in the second component assembly 118 receives the first separated signal and reflects the first separated signal. The non-reciprocal polarization rotator 110 in the second component assembly 118 receives the first separated signal and outputs a first FPSS signal. The letters FPSS represent First Polarization State Source and indicate that the light that was in the first polarization state after reflection by the object was the source of the light for the first FPSS signal.

The first separated signal travels through the non-reciprocal polarization rotator 110 in the opposite direction of the third rotated signal. As a result, the non-reciprocal polarization rotator 110 is configured to rotate the polarization state of the first separated signal by −n*90°−45°. Accordingly, the polarization state of the first FPSS signal is rotated by −45° from the polarization state of the first separated signal.

The 45° polarization rotator 112 in the second component assembly 118 receives the first FPSS signal and outputs a second FPSS signal. Because the 45° polarization rotator 112 is a reciprocal polarization rotator, the 45° polarization rotator 112 is configured to rotate the polarization state of the first FPSS signal by m*90°+45° where m is 0 or an even integer. As a result, the polarization state of the second FPSS signal is rotated by 45° from the polarization state of the first FPSS signal. The combined effect of the polarization state rotations provided by the non-reciprocal polarization rotator 110 and the 45° polarization rotator 112 in the second component assembly 118 is that the second FPSS signal has been rotated by 0° from the polarization state of the first separated signal. As a result, the second FPSS signal has the first polarization state.

The second FPSS signal is received at the third polarization beam splitter 114. The third polarization beam splitter 114 reflects the second FPSS signal and the second FPSS signal exits the circulator 104. After exiting the circulator 104, the second FPSS signal is received at a first beam steering component 132 configured to change the direction of travel of the second FPSS signal. Suitable first beam steering components 132 include, but are not limited to, mirrors and right-angled prism reflectors.

The second FPSS signal travels from the first beam steering component 132 to a second lens 134. The second lens 134 is configured to output the first LIDAR input signal represented by FLIS2. Additionally, the second lens 134 is configured to focus or collimate the first LIDAR input signal (FLIS₂) at a desired location. For instance, the second lens 134 can be configured to focus the first LIDAR input signal (FLIS₂) at an exit port on one of the first input waveguides 16. For instance, the second lens 134 can be configured to focus the first LIDAR input signal (FLIS₂) at a facet of one of the first input waveguides 16 as shown in FIG. 3A.

As described in the context of FIG. 1A and FIG. 1B, the first LIDAR input signal (FLIS2) enters one of the first input waveguides 16 and serves as a first comparative signal that is guided to one of the first processing components 34.

The 90° polarization rotator 122 in the second component assembly 118 receives the second separated signal 130 and outputs a first SPSS signal. The letters SPSS represent Second Polarization State Source and indicate that the light that was in the second polarization state after reflection by the object was the source of the light for the first SPSS signal. Because the 90° polarization rotator 122 is a reciprocal polarization rotator, the 90° polarization rotator 122 is configured to rotate the polarization state of the second separated signal 130 by n*90°+90° where n is 0 or an even integer. As a result, the polarization state of the first SPSS signal is rotated by 90° from the polarization state of the second separated signal 130. Accordingly, in the illustrated example, the first SPSS signal has the first polarization state.

The non-reciprocal polarization rotator 110 in the second component assembly 118 receives the first SPSS signal and outputs a second SPSS signal. The first SPSS signal travels through the non-reciprocal polarization rotator 110 in the opposite direction of the third rotated signal. As a result, the non-reciprocal polarization rotator 110 is configured to rotate the polarization state of the first SPSS signal by −n*90°−45°. Accordingly, the polarization state of the second SPSS signal is rotated by −45° from the polarization state of the first SPSS signal.

The 45° polarization rotator 112 in the second component assembly 118 receives the second SPSS signal and outputs a third FPSS signal. Because the 45° polarization rotator 112 is a reciprocal polarization rotator, the 45° polarization rotator 112 is configured to rotate the polarization state of the second SPSS signal by m*90°+45° where m is 0 or an even integer. As a result, the polarization state of the third SPSS signal is rotated by 45° from the polarization state of the second FPSS signal. The combined effect of the polarization state rotations provided by the non-reciprocal polarization rotator 110 and the 45° polarization rotator 112 in the second component assembly 118 is that the third SPSS signal has been rotated by 0° from the polarization state of the first SPSS signal. Additionally, the combined effect of the polarization state rotations provided by the non-reciprocal polarization rotator 110, the 45° polarization rotator 112, and the 90° polarization rotator 122 in the second component assembly 118 is that the third SPSS signal has been rotated by 90° from the polarization state of the second separated signal 130. Accordingly, in the illustrated example, the third SPSS signal is shown in the first polarization state.

The third SPSS signal is received at the third polarization beam splitter 114. The third polarization beam splitter 114 reflects the third SPSS signal such that the third SPSS signal exits the circulator 104. After exiting the circulator 104, the third SPSS signal is received at a second beam steering component 136 configured to change the direction of travel of the third SPSS signal. Suitable second beam steering components 136 include, but are not limited to, mirrors and right angled prism reflectors.

The third SPSS signal travels from the first beam steering component 132 to a third lens 138. The third lens 138 is configured to output the second LIDAR input signal represented by SLIS₂. Additionally, the third lens 138 is configured to focus or collimate the second LIDAR input signal (SLIS₂) at a desired location. For instance, the third lens 138 can be configured to focus the second LIDAR input signal (SLIS₂) at an exit port on one of the second input waveguides 36. For instance, the third lens 138 can be configured to focus the second LIDAR input signal (SLIS₂) at a facet of one of the second input waveguides 36 as shown in FIG. 3A.

As described in the context of FIG. 1A and FIG. 1B, the second LIDAR input signal (SLIS₂) enters one of the second input waveguides 36 and serves as a second comparative signal that is guided to one of the second processing components 40.

FIG. 3C illustrates the path that light from the LIDAR output signal that carries channel C₃ travels through the LIDAR system. The pre-circulator component 102 can be configured such that the light from different LIDAR output signals travel different paths through the circulator. For instance, the pre-circulator component 102 can be configured such that the light from different circulator input signals travel non-parallel paths through the circulator. In some instances, the pre-circulator component 102 is configured such that the different circulator input signals enter a first port of the circulator 104 traveling in different directions. For instance, the illustrated pre-circulator component 102 is a lens that receives the LIDAR output signals. The angle of incidence of the different LIDAR output signals on the lens can be different. For instance, in FIG. 3C, the LIDAR output signal carrying channel C₃ has a different incident angle on the first lens 102 than the incident angle of the LIDAR output signal carrying channel C₃. As a result, the circulator input signal carrying channel C₃ and the circulator input signal carrying channel C₂ travel away from the lens in different directions. Because the different circulator input signals travel away from the pre-circulator component 102 in different directions, the LIDAR output signals enter a first port 140 of the circulator 104 traveling in different directions.

Although the different circulator input signals enter the circulator 104 traveling in different directions, the light from the different circulator input signals are processed by the same selection of circulator components in the same sequence. For instance, the light from different circulator input signals travels through components in the sequence disclosed in the context of FIG. 3A and FIG. 3B. As a result, the light from the different circulator input signals exit from the circulator at a second port 142. For instance, the path of the light from the circulator input signal that carries channel C₃ through the circulator shows the outgoing circulator signal exiting from the circulator at a second port 142. Additionally, the light from the circulator return signal that carries channel C₃ enters the circulator at the second port 142. Similarly, the light from the circulator input signal carrying channel C₂ enters and exits the circulator at the second port 142 as described in the context of FIG. 3A and FIG. 3B.

A comparison of FIG. 3A and FIG. 3B shows that outgoing circulator signals approach the second port 142 from different directions and travel away from the circulator in different directions. The difference in the directions of the outgoing circulator signals can result from the circulator input signals entering the circulator from different directions.

FIG. 3C shows light from the outgoing circulator signal that carries channel C₃ exiting the LIDAR system as a system output signal that carries channel C₃. The direction that the system output signal carrying channel C₃ travels away from the LIDAR system is labeled d3 in FIG. 3C. FIG. 3C also includes the label d₂ from FIG. 3A. The label d₂ illustrates the direction that the system output signal that carries channel C₂ travels away from the LIDAR system. A comparison of the labels d₂ and d₃ shows that the system output signals carrying channel C₂ and C₃ travel away from the LIDAR system in different directions. As a result, different system output signals can concurrently illuminate different sample regions. LIDAR data can be generated for each of the different sample regions that are concurrently illuminated by the LIDAR system.

The system return signal carrying channel C₂ returns to the LIDAR system in the reverse direction of the arrow labeled d₂, or in substantially the reverse direction of the arrow labeled d₂. Additionally, the system return signal carrying channel C₂ returns to the LIDAR system in the reverse direction of the arrow labeled d₃, or in substantially the reverse direction of the arrow labeled d₃. As a result, different system return signals return to the LIDAR system from different directions. The light from the different system return signals travel through the sequence of components of the LIDAR system in the same sequence disclosed in the context of FIG. 3A and FIG. 3B.

Each of the circulator return signals carries light from a different one of the system return signals. The circulator return signals each enters the second port 142 traveling in a different direction. Accordingly, the light from the circulator return signals can each travel a different pathway through the circulator.

Light in the different the circulator return signals that was in the first polarization state after being reflected by the object (first polarization state source, FPSS) exits from the circulator 104 at a third port 144. For instance, FIG. 3C shows a second FPSS signal (includes the light from the system return signal that carries channel C₃) exiting the circulator from the third port 144. Similarly, the second FPSS signal that includes the light from the system return signal that carries channel C₂ also exits the circulator at the third port 144 as described in the context of FIG. 3A and FIG. 3B.

The different second FPSS signals travel away from the circulator in different directions. As a result, the different first input waveguides 16 on the LIDAR chip are positioned to receive different second FPSS signals is received. For instance, light from the second FPSS signal that carries channel C₃ is included in the first LIDAR input signal labeled FLIS3 and light from the second FPSS signal that carries channel C₂ is included in the first LIDAR input signal labeled FLIS₂. The first LIDAR input signal labeled FLIS₃ and the first LIDAR input signal labeled FLIS₂ are received at different first input waveguides 16. The different second FPSS signals traveling away from the circulator in different directions can be result of the circulator input signals entering the circulator in different directions. Accordingly, the LIDAR system can be configured such that the circulator input signals enter the circulator traveling in a direction that causes the second FPSS signals to travel away from the circulator in different non-parallel directions.

Light in the circulator return signals that was in the second polarization state after being reflected by the object (first polarization state source, FPSS) exits from the circulator 104 at a fourth port 146. For instance, FIG. 3C shows a third SPSS signal (includes the light from the system return signal that carries channel C₃) exiting the circulator from the fourth port 146. Similarly, the third SPSS signal that includes the light from the system return signal that carries channel C₂ also exits the circulator at the fourth port 146 as described in the context of FIG. 3A and FIG. 3B.

The different third SPSS signals travel away from the circulator in different directions. As a result, the light from the different third SPSS signals is received at different second input waveguides 36 on the LIDAR chip. For instance, light from the third SPSS signal that carries channel C₃ is included in the second LIDAR input signal labeled SLIS₃ and light from the third SPSS signal that carries channel C₂ is included in the second LIDAR input signal labeled SLIS₂. The second LIDAR input signal labeled SLIS₃ and the second LIDAR input signal labeled SLIS₂ are received at different first input waveguides 16. The different third SPSS signals traveling away from the circulator in different directions can be result of the circulator input signals entering the circulator in different directions. Accordingly, the LIDAR system can be configured such that the circulator input signals enter the circulator traveling in a direction that causes the third SPSS signals to travel away from the circulator in different non-parallel directions.

Each of the second LIDAR input signals (SLISᵢ) enters one of the second input waveguides 36 and serves as a second comparative signal that is guided to one of the second processing components 40. Since each of the second LIDAR input signals carries the light that was in the second polarization state after being reflected by the object (second polarization state sourced, SPSS), data generated from the second processing components 40 is LIDAR data from light that the object reflected in the second polarization state. In contrast, each of the first LIDAR input signals (FLISᵢ) enters one of the first input waveguides 16 and serves as a first comparative signal that is guided to one of the first processing components 34. Since each of the first LIDAR input signals carries the light that was in the first polarization state after being reflected by the object (first polarization state sourced, FPSS), data generated from the first processing components 34 is LIDAR data from light that the object reflected in the first polarization state.

The second FPSS signals and the third SPSS signals can serve as circulator output signals. The circulator output signals can include first circulator output signals and second circulator output signals. Each of the second FPSS signals can serve as one of the first circulator output signals. As a result, each of the first circulator output signals can include, include primarily, consist essentially of, and/or consist of light that was in the first polarization state when it was reflect by an object outside of the LIDAR system (FPSS). Each of the third SPSS signals can serve as one of the second circulator output signals. As a result, each of the second circulator output signals can include, include primarily, consist essentially of, and/or consist of light that was in the first polarization state when it was reflect by an object outside of the LIDAR system (SPSS).

A comparison of FIG. 3A and FIG. 3C shows that light from each of the circulator input signals is operated on by the same selection (a first selection) of circulator components when traveling from the first port 140 to the second port 142. For instance: the light from each of the circulator input signals is operated on by the first polarization beam splitter 106, the second polarization beam splitter 108, the non-reciprocal polarization rotator 110, and the 45° polarization rotator 112 from the component assembly 116; and also by the third polarization beam splitter 114; and also by the 45° polarization rotator 112, the non-reciprocal polarization rotator 110, the second polarization beam splitter 108, and the first polarization beam splitter 106 from the second component assembly 118. However, FIG. 3A and FIG. 3C also shows that the light from each of the each of the circulator input signals can travel a different pathway through the circulator. A comparison of FIG. 3B and FIG. 3C shows that light in each of the first circulator output signals is operated on by the same selection (a second selection) of circulator components when traveling from the second port 142 to the third port. However, FIG. 3B and FIG. 3C also shows that the in each of the first circulator output signals can travel a different pathway through the circulator. A comparison of FIG. 3B and FIG. 3C shows that light in each of the second circulator output signals is operated on by the same selection (a third selection) of circulator components when traveling from the second port 142 to the third port. However, FIG. 3B and FIG. 3C also shows that the light in each of the second circulator output signals can travel a different pathway through the circulator. As is evident from FIG. 3A through FIG. 3C, the first selection of components, the second selection of components, and the third selection of components can be different.

The outgoing circulator signals can each include, include primarily, consists of, or consists essentially of light from one of the circulator input signals. Additionally, the circulator return signals can each include, include primarily, consists of, or consists essentially of light from one of the circulator input signals, and one of the outgoing circulator signals. Further, the circulator output signals can each include, include primarily, consists of, or consists essentially of light from one of the circulator return signals, one of the outgoing circulator signals, and one of the circulator input signals.

The polarization beam splitters shown in FIG. 3A through FIG. 3C can have the construction of cube-type beamsplitters or Wollaston prisms. As a result, the components described as a beamsplitter can represent a beamsplitting component such as a coating, plate, film, or an interface between light-transmitting materials 150 such as a glass, crystal, birefringent crystal, or prism. A light-transmitting material 150 can include one or more coatings positioned as desired. Examples of suitable coating for a light-transmitting material 150 include, but are not limited to, anti-reflective coatings. In some instances, one, two, three, or four ports selected from the group consisting of the first port 140, the second port 142, the third port 144, and the fourth port 146 are all or a portion of a surface of the circulator. For instance, one, two, three, or four ports selected from the group consisting of the first port 140, the second port 142, the third port 144, and the fourth port 146 can each be all or a portion of a surface of the light-transmitting material 150 as shown in FIG. 3A and FIG. 3B. The surface of the circulator or light-transmitting material 150 that serves as a port can include one or more coatings.

In some instances, the components of the component assembly 116, the second component assembly 118, and/or the circulator 104 are immobilized relative to one another through the use of one or more bonding media such as adhesives, epoxies or solder. In some instances, the components of a component assembly 116 and/or a second component assembly 118 are immobilized relative to one another before being included in the circulator 104. Using a component assembly 116 and a second component assembly 118 with the same construction combined with immobilizing the components of these component assemblies before assembling of the circulator 104 can simplify the fabrication of the circulator.

Although the LIDAR system is disclosed as having a component assembly 116 and a second component assembly 118 with the same construction, the component assembly 116 and second component assembly 118 can have different constructions. For instance, the component assembly 116 can include a 90° polarization rotator 122 that is not used during the operation of the LIDAR system. As a result, the component assembly 116 can exclude the 90° polarization rotator 122. As another example, the component assembly 116 can include, or consist of, the non-reciprocal polarization rotator 110 and the 45° polarization rotator 112. In this example, the non-reciprocal polarization rotator 110 or the 45° polarization rotator 112 can receive the circulator input signals directly from the pre-circulator component 102. As a result, the component assembly 116 can exclude the first polarization beam splitter 106, the second polarization beam splitter 108, the associated light-transmitting material 150, and the 90° polarization rotator 122.

Additionally, the adapter components 99 can be re-arranged and/or are optional. For instance, the beam steering components such as first beam steering component 132 and second beam steering component 132 are optional and beam shaping components such as the second lens 134 and the third lens 138 can also be optional. As another example, the pre-circulator component 102 is optional. For instance, the LIDAR system can exclude the pre-circulator component 102 and the utility waveguide 13 can be arranged and/or configured such that the different circulator input signals enter the first port 140 traveling in the desired directions.

LIDAR chips include one or more waveguides that constrains the optical path of one or more light signals. While the LIDAR adapter can include waveguides, the optical path that the signals travel between components on the LIDAR adapter and/or between the LIDAR chip and a component on the LIDAR adapter can be free space. For instance, the signals can travel through the atmosphere in which the LIDAR chip, the LIDAR adapter, and/or the base 102 is positioned when traveling between the different components on the LIDAR adapter and/or between a component on the LIDAR adapter and the LIDAR chip. As a result, the components on the adapter can be discrete optical components that are attached to the base 102.

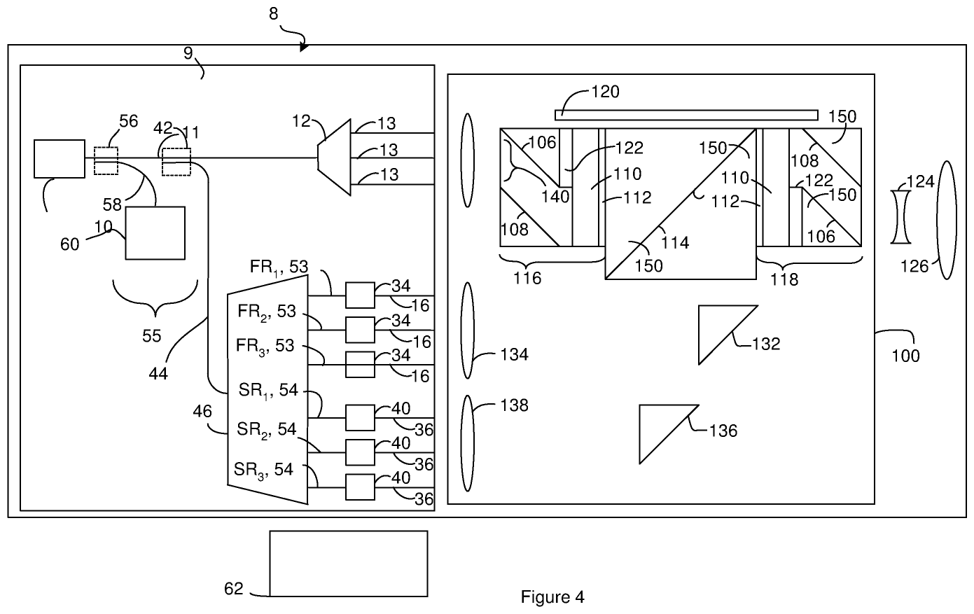

The LIDAR chip, electronics, and the LIDAR adapter can be positioned on a common mount. Suitable common mounts include, but are not limited to, glass plates, metal plates, silicon plates and ceramic plates. As an example, FIG. 4 is a topview of a LIDAR assembly that includes the LIDAR chip and electronics 62 of FIG. 2 and the LIDAR adapter of FIG. 3C on a common support 160. Although the electronics 62 are illustrated as being located on the common support, all or a portion of the electronics can be located off the common support. Suitable approaches for mounting the LIDAR chip, electronics, and/or the LIDAR adapter on the common support include, but are not limited to, epoxy, solder, and mechanical clamping. Although the beam shapers 124, collimator 126, and one or more steering components 128 are shown positioned on the common support 160, one or more components selected from the group consisting of the beam shapers 124, collimator 126, and one or more steering components 128 can be positioned off the common support 160.

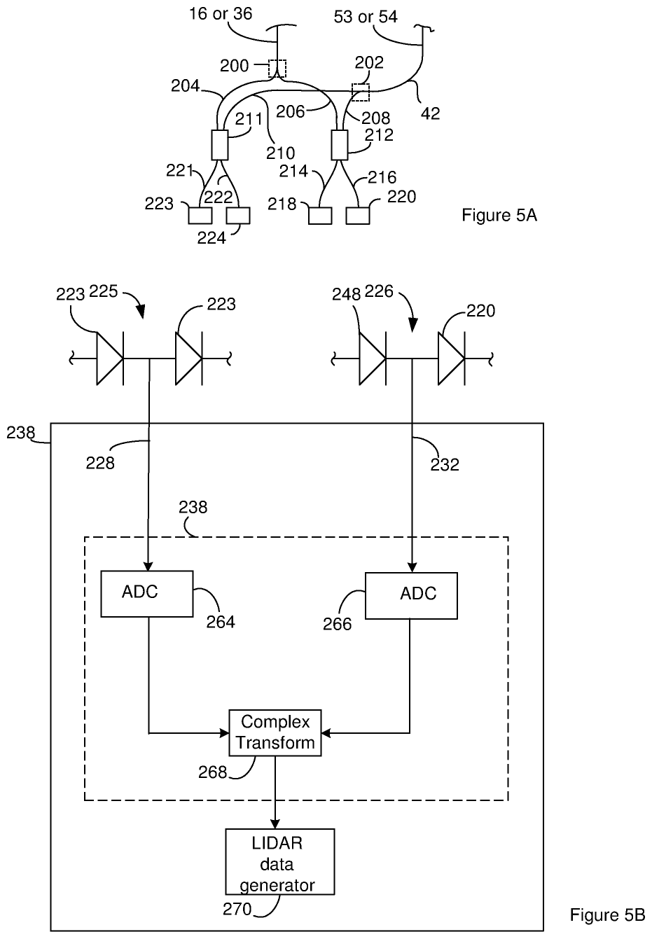

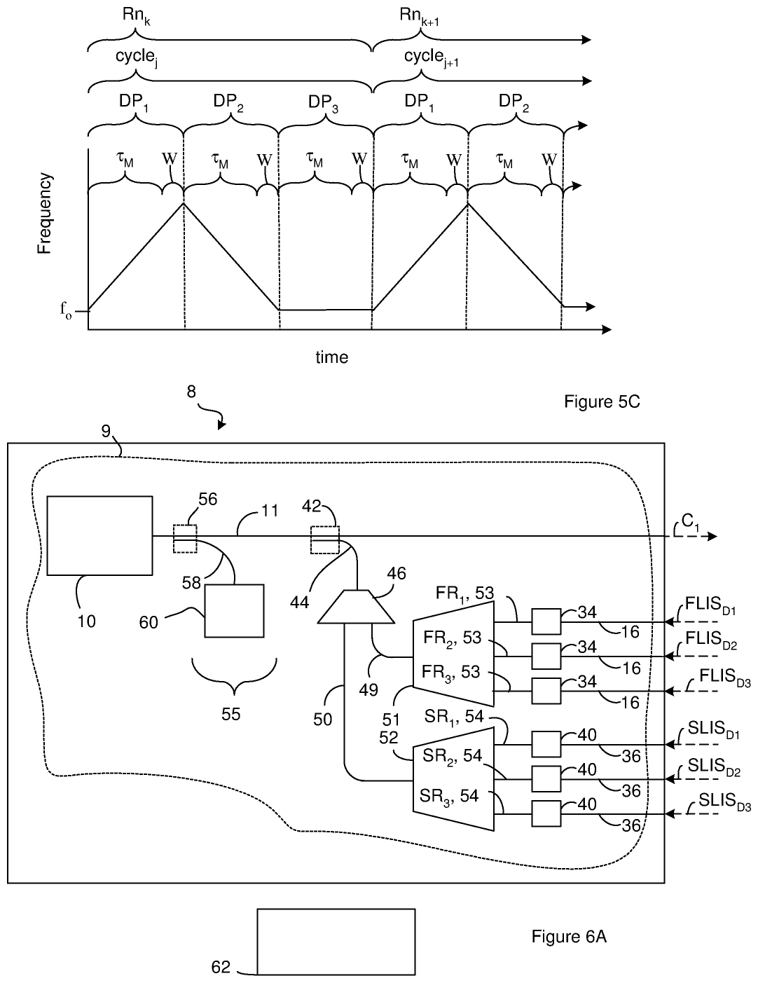

FIG. 5A through FIG. 5B illustrate an example of a processing component that is suitable for use as a first processing component 34 and/or a second processing component 40. As described in the context of FIG. 1, each processing component receives a comparative signal and a reference signal from a second input waveguide 36 and second reference waveguide 54 or from a first input waveguide 16 and a first reference waveguide 53. The processing component of FIG. 5A includes a first splitter 200 that divides a comparative signal carried on the first input waveguide 16 or the second input waveguide 36 onto a first comparative waveguide 204 and a second comparative waveguide 206. The first comparative waveguide 204 carries a first portion of the comparative signal to a light-combining component 211. The second comparative waveguide 206 carries a second portion of the comparative signal to a second light-combining component 212.

The processing component of FIG. 5A also includes a second splitter 202 that divides a reference signal carried on the first reference waveguide 53 or the second reference waveguide 54 onto a first reference waveguide 210 and a second reference waveguide 208. The first reference waveguide 210 carries a first portion of the reference signal to the light-combining component 211. The second reference waveguide 208 carries a second portion of the reference signal to the second light-combining component 212.

The second light-combining component 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal.

The second light-combining component 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include germanium photodiodes (PDs), and avalanche photodiodes (APDs).

In some instances, the second light-combining component 212 splits the second composite signal such that the portion of the comparative signal (i.e. the portion of the second portion of the comparative signal) included in the first portion of the second composite signal is phase shifted by 180° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second light-combining component 212 splits the second composite signal such that the portion of the reference signal (i.e. the portion of the second portion of the reference signal) in the first portion of the second composite signal is phase shifted by 180° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include germanium photodiodes (PDs), and avalanche photodiodes (APDs).

The first light-combining component 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The light-combining component 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second auxiliary light sensor 224 that converts the second portion of the second composite signal to a second electrical signal. Examples of suitable light sensors include germanium photodiodes (PDs), and avalanche photodiodes (APDs).

In some instances, the light-combining component 211 splits the first composite signal such that the portion of the comparative signal (i.e. the portion of the first portion of the comparative signal) included in the first portion of the composite signal is phase shifted by 180° relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the light-combining component 211 splits the composite signal such that the portion of the reference signal (i.e. the portion of the first portion of the reference signal) in the first portion of the composite signal is phase shifted by 180° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second light-combining component 212 splits the second composite signal such that the portion of the comparative signal in the first portion of the second composite signal is phase shifted by 180° relative to the portion of the comparative signal in the second portion of the second composite signal, the light-combining component 211 also splits the composite signal such that the portion of the comparative signal in the first portion of the composite signal is phase shifted by 180° relative to the portion of the comparative signal in the second portion of the composite signal. When the second light-combining component 212 splits the second composite signal such that the portion of the reference signal in the first portion of the second composite signal is phase shifted by 180° relative to the portion of the reference signal in the second portion of the second composite signal, the light-combining component 211 also splits the composite signal such that the portion of the reference signal in the first portion of the composite signal is phase shifted by 180° relative to the portion of the reference signal in the second portion of the composite signal.

The first reference waveguide 210 and the second reference waveguide 208 are constructed to provide a phase shift between the first portion of the reference signal and the second portion of the reference signal. For instance, the first reference waveguide 210 and the second reference waveguide 208 can be constructed so as to provide a 90 degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 210 and the second reference waveguide 208 are constructed such that the first reference signal portion is a cosine function and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

The first light sensor 223 and the second light sensor 224 can be connected as a balanced detector and the first auxiliary light sensor 218 and the second auxiliary light sensor 220 can also be connected as a balanced detector. For instance, FIG. 5B provides a schematic of the relationship between the electronics, the first light sensor 223, the second light sensor 224, the first auxiliary light sensor 218, and the second auxiliary light sensor 220. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 5B are included on the LIDAR chip. In some instances, the components illustrated in the schematic of FIG. 5B are distributed between the LIDAR chip and electronics located off of the LIDAR chip.

The electronics connect the first light sensor 223 and the second light sensor 224 as a first balanced detector 225 and the first auxiliary light sensor 218 and the second auxiliary light sensor 220 as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal. The first data signal is an electrical representation of the first composite signal and the second data signal is an electrical representation of the second composite signal. Accordingly, the first data signal includes a contribution from a first waveform and a second waveform and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e. the beating in the first composite signal and in the second composite signal.

The electronics 62 includes a transform mechanism 238 configured to perform a mathematical transform on the first data signal and the second data signal. For instance, the mathematical transform can be a complex Fourier transform with the first data signal and the second data signal as inputs. Since the first data signal is an in-phase component and the second data signal its quadrature component, the first data signal and the second data signal together act as a complex data signal where the first data signal is the real component and the second data signal is the imaginary component of the input.

The transform mechanism 238 includes a first Analog-to-Digital Converter (ADC) 264 that receives the first data signal from the first data line 228. The first Analog-to-Digital Converter (ADC) 264 converts the first data signal from an analog form to a digital form and outputs a first digital data signal. The transform mechanism 238 includes a second Analog-to-Digital Converter (ADC) 266 that receives the second data signal from the second data line 232. The second Analog-to-Digital Converter (ADC) 266 converts the second data signal from an analog form to a digital form and outputs a second digital data signal. The first digital data signal is a digital representation of the first data signal and the second digital data signal is a digital representation of the second data signal. Accordingly, the first digital data signal and the second digital data signal act together as a complex signal where the first digital data signal acts as the real component of the complex signal and the second digital data signal acts as the imaginary component of the complex data signal.

The transform mechanism 238 includes a transform component 268 that receives the complex data signal. For instance, the transform component 268 receives the first digital data signal from the first Analog-to-Digital Converter (ADC) 264 as an input and also receives the second digital data signal from the first Analog-to-Digital Converter (ADC) 266 as an input. The transform component 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of a comparative signal relative to the system output signal.

The electronics include a LIDAR data generator 270 that receives the output from the transform component 268 and processes the output from the transform component 268 so as to generate the LIDAR data (distance and/or radial velocity between the reflecting object and the LIDAR chip or LIDAR system). The LIDAR data generator performs a peak find on the output of the transform component 268 to identify one or more peaks in the beat frequency.

The electronics use the one or more frequency peaks for further processing to generate the LIDAR data (distance and/or radial velocity between the reflecting object and the LIDAR chip or LIDAR system). The transform component 268 can execute the attributed functions using firmware, hardware or software or a combination thereof.

FIG. 5C shows an example of a relationship between the frequency of the system output signal, time, cycles and data periods. Although FIG. 5C shows frequency versus time for only one channel, the illustrated frequency versus time pattern can represent the frequency versus time for each of the channels. The base frequency of the system output signal (f0) can be the frequency of the system output signal at the start of a cycle.

FIG. 5C shows frequency versus time for a sequence of two cycles labeled cycleⱼ and cycleⱼ₊₁. In some instances, the frequency versus time pattern is repeated in each cycle as shown in FIG. 5C. The illustrated cycles do not include re-location periods and/or re-location periods are not located between cycles. As a result, FIG. 5C illustrates the results for a continuous scan where the steering of the system output signal is continuous.

Each cycle includes K data periods that are each associated with a period index k and are labeled DPk. In the example of FIG. 5C, each cycle includes three data periods labeled DPk with k=1, 2, and 3. In some instances, the frequency versus time pattern is the same for the data periods that correspond to each other in different cycles as is shown in FIG. 5C. Corresponding data periods are data periods with the same period index. As a result, each data period DP₁ can be considered corresponding data periods and the associated frequency versus time patterns are the same in FIG. 5C. At the end of a cycle, the electronics return the frequency to the same frequency level at which it started the previous cycle.

During the data period DP₁, and the data period DP₂, the electronics operate the light source such that the frequency of the system output signal changes at a linear rate a. The direction of the frequency change during the data period DP₁ is the opposite of the direction of the frequency change during the data period DP₂.

FIG. 5C labels sample regions that are each associated with a sample region index k and are labeled Rnₖ. FIG. 5C labels sample regions Rnₖ and Rnₖ₊₁. Each sample region is illuminated with the system output signal during the data periods that FIG. 5C shows as associated with the sample region. For instance, sample region Rnₖ is illuminated with the system output signal during the data periods labeled DP₁ through DP₃. The sample region indices k can be assigned relative to time. For instance, the sample regions can be illuminated by the system output signal in the sequence indicated by the index k. As a result, the sample region Rn₁₀ can be illuminated after sample region Rn₉ and before Rn₁₁.

The LIDAR system is typically configured to provide reliable LIDAR data when the object is within an operational distance range from the LIDAR system. The operational distance range can extend from a minimum operational distance to a maximum operational distance. A maximum roundtrip time can be the time required for a system output signal to exit the LIDAR system, travel the maximum operational distance to the object, and to return to the LIDAR system and is labeled τ_{M} in FIG. 5C.

Since there is a delay between the system output signal being transmitted and returning to the LIDAR system, the composite signals do not include a contribution from the LIDAR signal until after the system return signal has returned to the LIDAR system. Since the composite signal needs the contribution from the system return signal for there to be a LIDAR beat frequency, the electronics measure the LIDAR beat frequency that results from system return signal that return to the LIDAR system during a data window in the data period. The data window is labeled “W” in FIG. 5C. The contribution from the LIDAR signal to the composite signals will be present at times larger than the maximum operational time delay (τ_{M}). As a result, the data window is shown extending from the maximum operational time delay (τ_{M}) to the end of the data period.

A frequency peak in the output from the Complex Fourier transform represents the beat frequency of the composite signals that each includes a comparative signal beating against a reference signal. The beat frequencies from two or more different data periods can be combined to generate the LIDAR data. For instance, the beat frequency determined from DP₁ in FIG. 5C can be combined with the beat frequency determined from DP₂ in FIG. 5C to determine the LIDAR data. As an example, the following equation applies during a data period where electronics increase the frequency of the outgoing LIDAR signal during the data period such as occurs in data period DP₁ of FIG. 5C: f_{ub}=−f_{d}+ατ where f_{ub} is the frequency provided by the transform component (f_{LDP} determined from DP₁ in this case),fƒ_{d} represents the Doppler shift (f_{d}=2νf_{c}/c) where f_{c} represents the optical frequency (fₒ), c represents the speed of light, ν is the radial velocity between the reflecting object and the LIDAR system where the direction from the reflecting object toward the chip is assumed to be the positive direction, τ is the time in which the light from the system output signal travels to the object and returns to the LIDAR system (the roundtrip time), and c is the speed of light. The following equation applies during a data period where electronics decrease the frequency of the outgoing LIDAR signal such as occurs in data period DP₂ of FIG. 5C: f_{db}=−f_{d}−ατ where f_{db} is a frequency provided by the transform component (f_{i, LDP} determined from DP₂ in this case). In these two equations, f_{d} and τ are unknowns. The electronics solve these two equations for the two unknowns. The radial velocity for the sample region then be determined from the Doppler shift (ν=c*f_{d}/(2f_{c})) and/or the separation distance for that sample region can be determined from c*τ/2. Since the LIDAR data can be generated for each corresponding frequency pair output by the transform, separate LIDAR data can be generated for each of the objects in a sample region. Accordingly, the electronics can determine more than one radial velocity and/or more than one radial separation distance from a single sampling of a single sample region in the field of view.

The data period labeled DP3 in FIG. 5C is optional. As noted above, there are situations where more than one object is present in a sample region. For instance, during the feedback period in DP₁ for cycle2 and also during the feedback period in DP₂ for cycle₂, more than one frequency pair can be matched. In these circumstances, it may not be clear which frequency peaks from DP₂ correspond to which frequency peaks from DP₁. As a result, it may be unclear which frequencies need to be used together to generate the LIDAR data for an object in the sample region. As a result, there can be a need to identify corresponding frequencies. The identification of corresponding frequencies can be performed such that the corresponding frequencies are frequencies from the same reflecting object within a sample region. The data period labeled DP₃ can be used to find the corresponding frequencies. LIDAR data can be generated for each pair of corresponding frequencies and is considered and/or processed as the LIDAR data for the different reflecting objects in the sample region.

An example of the identification of corresponding frequencies uses a LIDAR system where the cycles include three data periods (DP₁, DP₂, and DP₃) as shown in FIG. 5C. When there are two objects in a sample region illuminated by the LIDAR outputs signal, the transform component outputs two different frequencies for f_{ub}: f_{ub} and fu₂ during DP₁ and another two different frequencies for f_{db}: f_{d1} and fat during DP₂. In this instance, the possible frequency pairings are: (f_{d1}, fᵤ₁); (f_{d1}, fᵤ₂); and (f_{d2}, f_{d2}). A value of f_{d} and τ can be calculated for each of the possible frequency pairings. Each pair of values for f_{d} and τ can be substituted into ƒ₃=−ƒ_{d}+α₃α₃τ₀ to generate a theoretical ƒ₃ for each of the possible frequency pairings. The value of α₃ is different from the value of α used in DP₁ and DP₂. In FIG. 5C, the value of α₃ is zero. In this case, the transform component also outputs two values for ƒ₃ that are each associated with one of the objects in the sample region. The frequency pair with a theoretical f3 value closest to each of the actual ƒ₃ values is considered a corresponding pair. LIDAR data can be generated for each of the corresponding pairs as described above and is considered and/or processed as the LIDAR data for a different one of the reflecting objects in the sample region. Each set of corresponding frequencies can be used in the above equations to generate LIDAR data. The generated LIDAR data will be for one of the objects in the sample region. As a result, multiple different LIDAR data values can be generated for a sample region where each of the different LIDAR data values corresponds to a different one of the objects in the sample region.

The LIDAR data results described in the context of FIG. 5A through FIG. 5C are generated by a single processing component. Accordingly, the LIDAR data results described in the context of FIG. 5A through FIG. 5C are generated by a processing component 34 or a second processing component 40. However, as is evident from the above discussion, the LIDAR chip can include multiple processing components and different processing components receive comparative signals that include light that was in different polarization states after being reflected by an object located outside of the LIDAR system. For instance, when the LIDAR adapter is constructed as shown in FIG. 3A through FIG. 3C, the first processing components 34 receive a first comparative signal that includes light that was in the first polarization state after reflection by an object (FPSS) while the second processing components 40 receive a second comparative signal that includes light that was in the second polarization state after reflection by the object (SPSS). As a result, the LIDAR results generated from the processing components 34 are associated with a different polarization state than the LIDAR results generated from the second processing components 40.

The processing components 34 that receives a first comparative signal carrying channel i is associated with the second processing components 40 that receives the second comparative signal that is also carrying the same channel i. Since LIDAR data results can be generated from one of the processing components 34 and also from the associated second processing components 40, it is possible for multiple LIDAR data results to be generated for different channels and accordingly for different sample regions. Different LIDAR data results that are generated for a channel and/or accordingly for a sample region may be the same, substantially the same, or different.

In some instances, determining the LIDAR data for a sample region includes the electronics combining the LIDAR data from different associated processing components. Combining the LIDAR data can include taking an average, median, or mode of the LIDAR data generated from associated processing components. For instance, the electronics can average the distances between the LIDAR system and the reflecting object determined from associated processing components and/or the electronics can average the radial velocities between the LIDAR system and the reflecting object determined from associated processing components.

In some instances, determining the LIDAR data for a sample region includes the electronics identifying one of the associated processing components (i.e. the processing component 34 or the associated second processing components 40) as the source of the LIDAR data that is most represents reality (the representative LIDAR data). The electronics can then use the LIDAR data from the identified processing component as the representative LIDAR data to be used for additional processing. For instance, the electronics can identify which one of several associated processing components generated a composite signal with the largest amplitude or which one of several associated processing components has a transform component 268 that outputs the frequency peak with the highest amplitude. The electronics can select the LIDAR data of the identified processing components as having the representative LIDAR data and can use the LIDAR data from the identified signal for further processing by the LIDAR system. In some instances, the electronics combine identifying the processing components that provided the representative LIDAR data with combining LIDAR data from different processing components. For instance, the electronics can identify which processing component(s) from multiple associated processing components has a composite signals with an amplitude above an amplitude threshold as having representative LIDAR data and when more than two composite signals are identified as having representative LIDAR data, the electronics can combine the LIDAR data from each of identified processing components. When one processing component is identified as having representative LIDAR data, the electronics can use the LIDAR data from that processing component as the representative LIDAR data. When none of the processing components is identified as providing representative LIDAR data, the electronics can discard the LIDAR data for the sample region associated with those processing components.

There are increasing demands for LIDAR systems that can perform over a larger range of distances. The above LIDAR system can be used to overcome challenges with LIDAR systems configured to operate at large distance ranges. One of the challenges for operating a LIDAR system over a large distance range is that the one or more beam steering components 128 continues to steer the system output signal while the light from the system output signal is traveling from the LIDAR system to the object and then back to the LIDAR system as a system return signal. As noted above, the one or more beam steering components 128 receive the system return signal and output a steered return signal. The steering of the system output signal also results in steering the direction of the steered return signal output by the one or more beam steering components 128. As a result, the direction that the steered return signal will travel away from the one or more beam steering components 128 changes in response to steering of the system output signal that occurs while the light is traveling to and from the object for the roundtrip time (τ).

The amount of time that the one or more beam steering components 128 have available to change the direction that the steered return signal will travel away from the one or more beam steering components 128 increases as the roundtrip time (τ) increases. The roundtrip times (τ) increases as the distance of the object from the LIDAR system increases. As a result, increasing the distance of the object from the LIDAR system provides the one or more beam steering components 128 with more time to change the direction that the system return signal is steered. Accordingly, the amount of change that occurs to the direction that the steered return signal will travel away from the one or more beam steering components 128 increases as the distance of the object from the LIDAR system increases. This change in the direction that the steered return signal will travel away from the one or more beam steering components 128 can cause light from system return signal to partially or fully miss a return waveguide. For instance, this change in the direction that the steered return signal will travel away from the one or more beam steering components 128 can change the pathway of the steered return signal through the circulator. This change in the pathway through the circulator can be enough cause all or a portion of the resulting first LIDAR input signal to miss the first input waveguides 16 toward which it is directed. As a result, it may be difficult or even impossible to generate the LIDAR data for objects at certain distances from the LIDAR system.

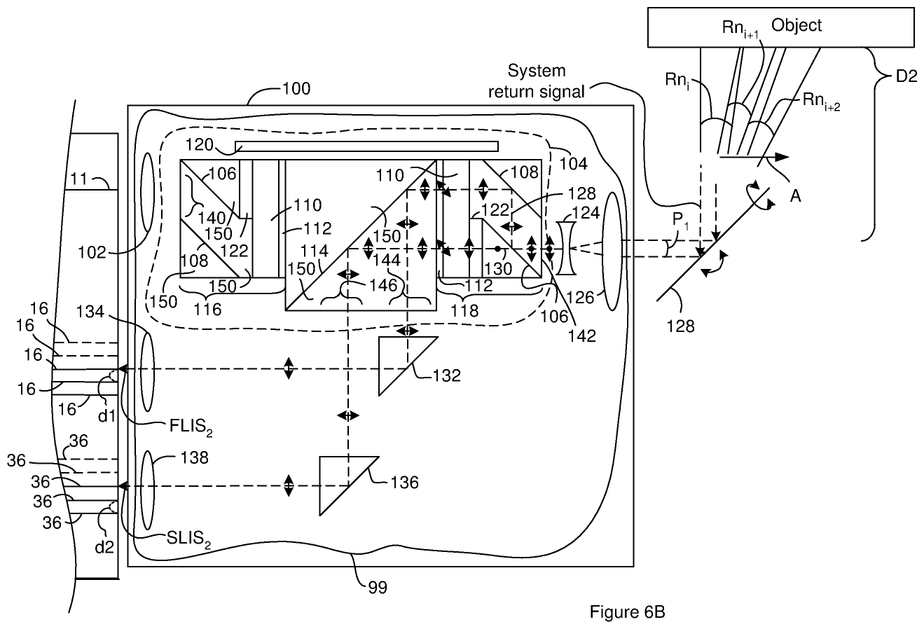

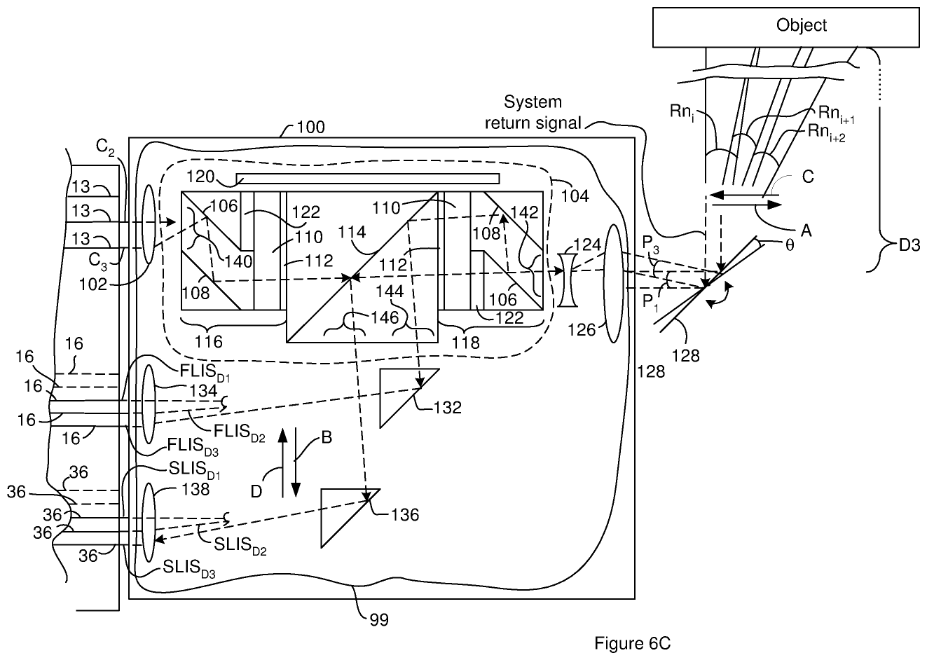

The above LIDAR systems can be used to reliably generate LIDAR data for objects at different locations with large operational distance ranges. For instance, FIG. 6A illustrates the LIDAR chip of FIG. 2 modified such that the source waveguide 11 serves as a utility waveguides 13 that carries the outgoing LIDAR signals to an exit port through which the outgoing LIDAR signal exits from the LIDAR chip and serves as a LIDAR output signal.

The LIDAR chip includes one or more first input waveguides 16. Each of the first input waveguides 16 can receive a first LIDAR input signal that includes or consists of light from the system return signal that resulted from reflection of the LIDAR output signal by an object. The first LIDAR input signal can be represented by FLIS_{Di} where Di represents a distance with a distance index i where the value of Di is different for different values of the distance index i. Accordingly, D1, D2, and D3, etc. would each represent a different distance. The labels D1, D2, and D3, etc. can be assigned such that D3>D2>D1. When the first LIDAR input signal carries light that has been reflected by an object located at a distance Di, the first LIDAR input signal is labeled FLIS_{Di} and is received at one of the first input waveguides 16. Accordingly, the first input signal can be labeled differently in response to the object being located different distances from the LIDAR system. The first LIDAR input signal enters one or more of the first input waveguides 16. The one or more of the first input waveguides 16 that receive the first LIDAR input signal is a function of the distance of the object from the LIDAR system. The portion of the first LIDAR input signal that enters a first input waveguide 16 serves as a first comparative signal. A first input waveguide 16 that receives a first comparative signal carries the first comparative signal to a first processing component 34.

The LIDAR chip includes one or more second input waveguides 36. Each of the second input waveguides 36 can receive the second LIDAR input signal that includes or consists of light from the system return signal that results from reflection of the system output signal. The second LIDAR input signal can be represented by SLIS_{Di} where Di represents the distance with the distance index i. Accordingly, the second LIDAR input signal can be labeled differently in response to the object being located different distances from the LIDAR system. The second LIDAR input signal enters one or more of the second input waveguides 36. The second input waveguide(s) 36 that receive the second LIDAR input signal is a function of the distance of the object from the LIDAR system. The portion of the second LIDAR input signal that enters a second input waveguide 36 serves as a second comparative signal. A second input waveguide 36 that receives a second comparative signal carries the second comparative signal to a second processing component 40.

FIG. 6B and FIG. 6C each shows the LIDAR system of FIG. 3A modified for use with the LIDAR chip of FIG. 6A. Although the LIDAR system is shown with the pre-circulator component 102, the pre-circulator component 102 is optional. The light from the LIDAR output signal travels from the LIDAR chip through the adapter until it exits the LIDAR system as a system output signal on the same or substantially the same as the path that LIDAR output signal carrying channel C₂ travels through the adapter of FIG. 3A. As a result, FIG. 6B and FIG. 6C each illustrates the path that light from the system return signals travels through the adapter until it enters the LIDAR chip in a first LIDAR input signal and a second LIDAR input signal.

FIG. 6B and FIG. 6C each illustrates a portion of the sample regions (labeled Rnᵢ through Rnᵢ₊₂) that are scanned by the system output signal. The electronics operate the one or more beam steering components 128 such that the system output signal is scanned in the direction of the arrow labeled A. As a result, the sample regions are scanned in the sequence Rnᵢ, Rnᵢ₊₁, Rnᵢ₊₂.

In FIG. 6B, the object is located at a distance D1 from the LIDAR system. In contrast, FIG. 6C illustrates the LIDAR system of FIG. 6B but with the object located at a distance D3 from the LIDAR system. The distances D1, D2, and D3 are arranged such that D3>D2>D1. As a result, the object in FIG. 6B is closer to the LIDAR system than the object in FIG. 6C. Changing the distance between the object and the LIDAR system changes the amount of time that the one or more beam steering components 128 have to steer the system output signal before the system output signal returns to the one or more beam steering components 128. For instance, as the object moves further from the LIDAR system, the beam steering components 128 have more time to steer the system output signal before the system output signal returns to the one or more beam steering components 128. This principal is illustrated by the roundtrip delay angle labeled 0 in FIG. 6C. The angle labeled θ represents the amount of movement in the one or more beam steering components 128 that occurs during the roundtrip time τ (time between the system output signal being output from the one or more beam steering components 128 and the system return signal returning to the one or more beam steering components 128). Because the roundtrip time τ increases as the distance between the object and the LIDAR system increases, the value of the roundtrip delay angle θ is substantial and is evident in FIG. 6C. In contrast, the roundtrip delay angle θ is not evident in FIG. 6B due to the close proximity of the object and the LIDAR system.

The change to the roundtrip delay angle θ that results from increasing distance changes the path that the steered return signal travels away from the one or more beam steering components 128. For instance, the path that the steered return signal travels when the object is located at distance D1 is labeled Pi in FIG. 6B and in FIG. 6C. The path that the steered return signal travels when the object is located at distance D3 is labeled P3 in FIG. 6B and in FIG. 6C. As is evident from a comparison of FIG. 6B and FIG. 6C and/or from the discussion of FIG. 3A through FIG. 3C, the different paths cause the light from the steered return signals to enter the second port 142 of the circulator traveling in a different direction. Since the light from the steered return signals to enter the second port 142 of the circulator traveling in different directions, the light from the steered return signals travel different paths through the circulator as disclosed in the context of FIG. 3B and FIG. 3C. For instance, the path that the light from the steered return signal of FIG. 6B travels through the circulator can be compared to the path that the light from the steered return signal of FIG. 3B travels through the circulator. Additionally, the path that the light from the steered return signal of FIG. 6C travels through the circulator can be compared to the path that the light from the steered return signal of FIG. 3C travels through the circulator. Accordingly, when the object is at different distance from the LIDAR system the light from the resulting system return signals travel a different pathway through the circulator. As a result, changing the distance between the object and the LIDAR system changes the pathway that the light from the resulting system return travels through the circulator.

The first input waveguides 16 are positioned to receive a first LIDAR input signal that result from the object being at different distances from the LIDAR system. For instance, FIG. 6C shows one of the first input waveguides 16 positioned to receive the first LIDAR input signal that results from the object being positioned at distance D1 from the LIDAR system (labeled FLIS_{D1}), another first input waveguide 16 positioned to receive the first LIDAR input signal that results from the object being positioned at distance D2 from the LIDAR system (labeled FLIS_{D2}), and another first input waveguide 16 positioned to receive the first LIDAR input signal that results from the object being positioned at distance D3 from the LIDAR system (labeled FLIS_{D3}).

An object can be positioned at distances other than D1, D2, and D3 from the LIDAR system. As a result, at some distances, a first LIDAR input signal can be received by more than one of the first input waveguides 16. For instance, when an object is positioned between D1 and D2, the resulting first LIDAR input signal can be received by two of the first input waveguides 16. In some instance, when an object is positioned at, between or beyond locations D1, D2, and D3 from the LIDAR system, the a first LIDAR input signal is received by more than one of the first input waveguides 16.

The second input waveguides 36 can be positioned to receive the second LIDAR input signal that result from the object being at different distances from the LIDAR system. For instance, FIG. 6C shows one of the second input waveguides 36 positioned to receive the second LIDAR input signal that results from the object being positioned at distance D1 from the LIDAR system (labeled SLIS_{D1}), another second input waveguide 36 positioned to receive the second LIDAR input signal that results from the object being positioned at distance D2 from the LIDAR system (labeled SLIS_{D2}), and another second input waveguide 36 positioned to receive the second LIDAR input signal that results from the object being positioned at distance D3 from the LIDAR system (labeled SLIS_{D3}).

An object can be positioned at distances other than D1, D2, and D3 from the LIDAR system. As a result, at some distances, a second LIDAR input signal can be received by more than one of the second input waveguides 36. For instance, when an object is positioned between D1 and D2, the resulting second LIDAR input signal can be received by two of the second input waveguides 36. In some instance, when an object is positioned at, between or beyond locations D1, D2, and D3 from the LIDAR system, the second LIDAR input signal is received by more than one of the second input waveguides 36.

The first input waveguides 16 each have a first port through which the first LIDAR input signals can enter the first input waveguide 16. For instance, the first input waveguides 16 can each terminate at a facet through which the first LIDAR input signals enter the first input waveguide 16. The distance between the first ports (an example is labeled d1 in FIG. 6B) is selected such that the first input signal enters the ports of different first input waveguides 16 in response to the object being at different locations within the operational distance range of the LIDAR system. Examples of distances between the ports (d1) include, but are not limited to, distances greater than 0 μm, 1 μm, 2 μm, or 3 μm and/or less than 5 μm, 10 μm, 15 μm, or 150 μm.

The second input waveguides 36 each have a port through which the second LIDAR input signals can enter the second input waveguide 36. For instance, the second input waveguides 36 can each terminate at a facet through which the second LIDAR input signals enter the second input waveguide 36. The distance between the second ports (an example is labeled d2 in FIG. 6B) is selected such that the second input signal enters the ports of different second input waveguides 36 in response to the object being at different locations within the operational distance range of the LIDAR system. Examples of distances between the ports (d2) include, but are not limited to, distances greater than 0 μm, 1 μm, 2 μm, or 3 μm and/or less than 5 μm, 10 μm, 15 μm, or 150 μm.

The first input waveguide 16 that receives FLIS_{D1} and the second input waveguide 36 that receives SLIS_{D1} are the lowest proximity waveguides because they receive the LIDAR input signals that are generated when the object is closest to the LIDAR system and within the operational distance range of the LIDAR system. When the system output signal is scanned in the direction of the arrow labeled A and the distance between an object and the LIDAR system increases, the first LIDAR input signal and the second LIDAR input signal moves away from the lowest proximity waveguides in the direction of the arrow labeled B in FIG. 6C. As a result, as the maximum operation distance of the LIDAR system is increased, additional first input waveguides 16 and/or second input waveguides 36 can be added in the direction of the arrow labeled B.

When the sample regions in a field of view have been scanned as desired, it is generally desirable to repeat the scan of the sample regions in the field of view. The scan can be repeated by returning the system output signal to the first sample region in the sequence of sample regions and scanning the sample regions in the same sequence. The system output signal can be returned to the first sample region by steering the system output signal from the last sample region in the sequence back to the first sample region in the sequence. Alternately, the one or more beam steering components 128 can be a prismatic mirror that re-sets the system output signal at the first sample region. As an alternative, when the sample regions in a field of view have been scanned as desired, the scan of a field of view can be repeated by scanning the sample regions in the reverse sequence.

The scanning of the sample regions can result in the system output signal being moved in the direction labeled A and/or in the reverse direction illustrated by the arrow labeled C in FIG. 6C. When scanning of the sample regions results in movement of the system output signal being in the reverse of the direction illustrated by the arrow labeled C, increasing the distance between the object and the LIDAR system moves the first LIDAR input signal and the second LIDAR input signal away from the lowest proximity waveguides in the direction of the arrow labeled D in FIG. 6C. As a result, additional first input waveguides 16 and/or second input waveguides 36 can be added moving away from the lowest proximity waveguides in the direction of the arrow labeled D. For instance, the first input waveguides 16 and the second input waveguides 36 shown by the dashed lines can be added. As a result, the LIDAR chip can include one or more first input waveguides 16 on one or both sides of the first input waveguide 16 that serves as a lowest proximity waveguide. Additionally or alternately, the LIDAR chip can include one or more second input waveguides 36 on one or both sides of the second input waveguide 36 that serves as a lowest proximity waveguide.

The presence of multiple first input waveguides 16 allows the first LIDAR input signal to be collected even when the distance between the LIDAR system and the object is increases enough for the first LIDAR input signal to move away from the lowest proximity waveguide. Similarly, the presence of multiple second input waveguides 36 allows the second LIDAR input signal to be collected even when the distance between the LIDAR system and the object is increases enough for the first LIDAR input signal to move away from the lowest proximity waveguide. The ability to continue collecting the LIDAR input signal even at large separation distances allows LIDAR data to be reliable generated for LIDAR systems with large operational distance ranges.

As described above, one or more of the first input waveguides 16 receives at least a portion of a first LIDAR input signal. As a result, LIDAR data results for the same sample region can be generated at more than one first processing component 34. The electronics can be configured to identify the first processing component 34 that is the source of the LIDAR data that is most represents reality (the first representative LIDAR data). For instance, the electronics can identify which one of several first processing components 34 generated a composite signal with the largest amplitude or which one of several the first processing component 34 has a transform component 268 that output the frequency peak with the highest amplitude. The electronics can select the LIDAR data results from the identified processing components as having the first representative LIDAR data and can use the first representative LIDAR data in further processing by the LIDAR system.

Additionally, one or more of the second input waveguides 36 receives at least a portion of a second LIDAR input signal. As a result, LIDAR data results for the same sample region can be generated at more than one second processing component 40. The electronics can be configured to identify the second processing component 40 that is the source of the LIDAR data that is most represents reality (the second representative LIDAR data). For instance, the electronics can identify which one of several second processing components 40 generated a composite signal with the largest amplitude or which one of several the second processing components 40 has a transform component 268 that outputs the frequency peak with the highest amplitude. The electronics can select the LIDAR data results from the identified second processing component 40 as having the second representative LIDAR data and can use the second representative LIDAR data in further processing by the LIDAR system.

As an alternative to identifying the first processing component 34 that generated the first representative LIDAR data, the first processing components 34 can be combined so as to generate the first representative LIDAR data result. For instance, the outputs of the transform components 268 in the first processing component 34 can be added and the peak finder applied to the result. The results of the peak finder can be used to generate LIDAR data as discussed above and the resulting LIDAR data can serve as the first representative LIDAR data. As another example, the LIDAR data generated at each of the first processing components 34 can be averaged to generate the first representative LIDAR data.

As an alternative to identifying the second processing component 40 that generated the second representative LIDAR data, the second processing component 40 can be combined so as to generate the second representative LIDAR data result. For instance, the outputs of the transform components 268 in the second processing component 34 can be added and the peak finder applied to the result. The results of the peak finder can be used to generate LIDAR data as discussed above and the resulting LIDAR data can serve as the second representative LIDAR data. As another example, the LIDAR data generated at each of the second processing components 40 can be averaged to generate the second representative LIDAR data.

In instances when the LIDAR system generates the first representative LIDAR data but not the second representative LIDAR data, the first representative LIDAR can serve as the representative LIDAR data. In instances when the LIDAR system generates the second representative LIDAR data but not the first representative LIDAR data, the second representative LIDAR can serve as the representative LIDAR data.

In instances when the LIDAR system generates first representative LIDAR data and second representative LIDAR data, the electronics can identify whether the first representative LIDAR data or the second representative LIDAR data most represents reality (i.e. serves as the representative LIDAR data). The electronics can then use the representative LIDAR data for additional processing. For instance, the electronics can identify whether the first processing components 34 or the second processing components 40 have generated a composite signal with the largest amplitude or whether the first processing components 34 or the second processing components 40 have a transform component 268 that outputs the frequency peak with the highest amplitude. The electronics can select the LIDAR data results from the identified processing components as having the representative LIDAR data and can use the LIDAR data from the identified signal for further processing by the LIDAR system. For instance, when the electronics identify the first processing components 34, the electronics can use the first representative LIDAR data as the representative LIDAR data. When the electronics identify the first processing components 34, the electronics can use the first representative LIDAR data as the representative LIDAR data. In some instances, the electronics combine the first representative LIDAR data and the second representative LIDAR data. For instance, an average of the first representative LIDAR data and the second representative LIDAR data can serve as the representative LIDAR data.

In addition or as an alternative to generating LIDAR data, the LIDAR system can be used to determine different characteristics of an object that reflects a system output signal because the relative proportion of TE and TM polarization states may be changed upon reflection, and the amount of change depends upon properties including material composition and surface quality. For instance, the signals associated with different polarization states can indicate material type, surface roughness, or the presence of surface coatings or contaminants. Accordingly, in some instances, the electronics can use ratios of one more signal features to identify material characteristics such as surface roughness, or the presence of surface coatings or contaminants. For instance, the electronics can compare the signal feature ratio to one or more criteria such as ratio thresholds. The electronics can determine or approximate a value for the material characteristic, a presence or absence of the material characteristic, and/or a presence or absence of the material in response to the result(s) of the comparison of the ratio to the one or more criteria. Examples of signal feature ratios include, but are not limited to, ratio of composite signal amplitudes for composite signals that include light from the same sample region but are associated with different polarization states, ratio of comparative signal amplitudes for comparative signals that include light from the same sample region but are associated with different polarization states, and the ratio of LIDAR input signal amplitudes for LIDAR input signals that include light from the same sample region but are associated with different polarization states.

Although the LIDAR system of FIG. 6A through FIG. 6B is disclosed as having three first input waveguides 16, the LIDAR system can have two or more first input waveguides 16. Additionally or alternately, although the LIDAR system of FIG. 6A through FIG. 6B is disclosed as having three second input waveguides 36, the LIDAR system can have two or more second input waveguides 36.

The LIDAR system of FIG. 6A through FIG. 6C is illustrated as outputting a single channel for the purpose of simplifying the illustrations. However, the LIDAR system of FIG. 6A through FIG. 6C can be modified for use with multiple channels as disclosed in the context of FIG. 1 through FIG. 5C.

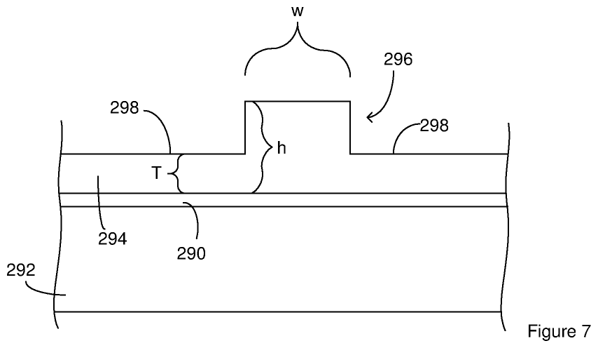

Suitable platforms for the LIDAR chips include, but are not limited to, silica, indium phosphide, and silicon-on-insulator wafers. FIG. 7 is a cross-section of portion of a chip constructed from a silicon-on-insulator wafer. A silicon-on-insulator (SOI) wafer includes a buried layer 290 between a substrate 292 and a light-transmitting medium 294. In a silicon-on-insulator wafer, the buried layer is silica while the substrate and the light-transmitting medium are silicon. The substrate of an optical platform such as an SOI wafer can serve as the base for the entire chip. For instance, the optical components shown in FIG. 1 can be positioned on or over the top and/or lateral sides of the substrate.

The portion of the chip illustrated in FIG. 7 includes a waveguide construction that is suitable for use with chips constructed from silicon-on-insulator wafers. A ridge 296 of the light-transmitting medium extends away from slab regions 298 of the light-transmitting medium. The light signals are constrained between the top of the ridge and the buried oxide layer.

The dimensions of the ridge waveguide are labeled in FIG. 7. For instance, the ridge has a width labeled w and a height labeled h. A thickness of the slab regions is labeled T. For LIDAR applications, these dimensions can be more important than other dimensions because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction of FIG. 7 is suitable for all or a portion of the waveguides on LIDAR chips constructed according to FIG. 1 through FIG. 4.

Although the LIDAR systems are disclosed as processing light signals having two different polarization states, in some instances, the LIDAR system includes the disclosed circulator 104 but is only configured to process the light signals that are the reflected by the object in only one of the polarization states. As a result, the components that process the light signals that include light reflected by the object in the first polarization state can be optional. Alternately, the components that process the light signals that include light reflected by the object in the second polarization state can be optional. As an example, the LIDAR systems can be modified to process the light signals that include light reflected by the object in the first polarization state but not in the second polarization state. For instance, the LIDAR systems can be modified to exclude the second beam steering component 136, third lens 138, the second input waveguides 36, second processing components 40, second intermediate waveguide 50, and second channel splitter 52. In another example, the LIDAR systems are modified to process the light signals that include light reflected by the object in the second polarization state but not in the first polarization state.

Numeric labels such as first, second, third, etc. are used to distinguish different features and components and do not indicate sequence or existence of lower numbered features. For instance, a second component can exist without the presence of a first component and/or a third step can be performed before a first step.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A LIDAR system, comprising:
a circulator configured to concurrently output multiple different outgoing circulator signals;
the circulator configured to receive multiple different circulator return signals, each of the circulator return signals including light that was included in one of the outgoing circulator signals and was reflected by one or more objects located outside of the LIDAR system; and
the circulator configured to output multiple circulator output signals, each of the circulator output signals including light from one of the circulator return signals; and
electronics configured to use the circulator output signals to generate one or more LIDAR data results selected from a group consisting a distance and a radial velocity between the LIDAR system and the one or more objects.

2. The system of claim 1, wherein a portion of the circulator output signals are first circulator output signals and a portion of the circulator output signals are second circulator output signals,
the first circulator output signals include primarily light that was reflected by the one or more objects in a first polarization state, and
the second circulator output signals include primarily light that was reflected by the one or more objects in a second polarization state.

3. The system of claim 2, wherein the first polarization state and the second polarization state are linear polarization states.

4. The system of claim 3, wherein each of the circulator output signals consists essentially of light in a polarization state selected from the group consisting of the first polarization state and the second polarization state.

5. The system of claim 2, wherein the circulator includes multiple different optical components, a third port through which the first circulator output signals exit the circulator, and a fourth port through which the second circulator output signals exit the circulator,
light from each of the circulator return signals being processed by a first selection of the optical components as the light from each of the circulator input signals travels on a different pathway from the second port to the third port, and
light from each of the circulator return signals being processed by a second selection of the optical components as the light from each of the circulator input signals travels on a different pathway from the second port to the third port, the second selection of the optical components being different from the first selection of the optical components.

6. The system of claim 4, wherein the circulator is configured to receive multiple circulator input signals,
each of the outgoing circulator signals consists essentially of light from a different one of the circulator input signals, and
each of the circulator input signals consists essentially of light in a polarization state selected from the group consisting of the first polarization state and the second polarization state.

7. The system of claim 2, wherein the circulator output signals include multiple pairs, each pair of circulator output signals including one of the first circulator output signals and one of the second circulator output signals, and the first circulator output signal and the second circulator output signal in each of the pairs including primarily light from the same circulator return signal.

8. The system of claim 1, the LIDAR system is configured to output multiple system output signals and each of the system output signals consists essentially of light from one of the outgoing circulator signals.

9. The system of claim 1, wherein each of the different outgoing LIDAR signals carries a different channel and the different channels are each at a different wavelength.

10. The system of claim 1, wherein each of the different outgoing LIDAR signals carries a different channel and the different channels are each at the same wavelength.

11. The system of claim 1, wherein the circulator is configured to receive multiple circulator input signals and each of the outgoing circulator signals includes light from a different one of the circulator input signals.

12. The system of claim 11, wherein the multiple circulator input signals enter the circulator traveling in different directions.

13. The system of claim 12, wherein the different directions are non-parallel.

14. The system of claim 11, wherein the circulator receives the circulator input signals from a lens.

15. The system of claim 14, wherein the circulator input signals each travels a different non-parallel direction away from the lens.

16. The system of claim 11, wherein the circulator includes multiple different optical components, a first port through which the circulator input signals enter the circulator, and a second port through which the outgoing circulator signals exit the circulator; and
light from each of the circulator input signals being processed by the same selection of the optical components as the light from each of the circulator input signals travels on a different pathway from the first port to the second port.

17. The system of claim 16, wherein the optical components include multiple polarization beam splitters and multiple polarization rotators.

18. The system of claim 16, wherein the components are arranged with a polarization beam splitter between a first assembly of the components and a second assembly of the components,
the first assembly and the second assembly each having the same construction and being interchangeable,
the first assembly and the second assembly each including a polarization beam splitter and a polarization rotator.

19. The system of claim 1, wherein each of the outgoing circulator signals travels away from the circulator in a different non-parallel direction.

20. A system, comprising:
a LIDAR system configured to direct a system output signal multiple different sample regions in a field of view,
the LIDAR system including multiple waveguides that are each configured to receive a light signal that includes light from the system output signal, and
the waveguide that receives the light signal is a function of the distance between the LIDAR system and the object; and
electronics configured to generate LIDAR data for each sample region, the LIDAR data for each sample region indicates the distance and/or radial velocity between the LIDAR system and an object in the sample region.
